(19) United States
(12) Patent Application Publication
(10) Pub. No.: US 2013/0132644 A1
(43) Pub. Date: May 23, 2013

(54) METHOD OF PROGRAMMING A NONVOLATILE MEMORY DEVICE

(71) Applicants: Seong-Hyeog CHOI, Hwaseong-si (KR); Jun-jin KONG, Yongin-si (KR); Hong-Rak SON, Anyang-si (KR); Sang-Yong YOON, Seoul (KR)

(72) Inventors: Seong-Hyeog CHOI, Hwaseong-si (KR); Jun-jin KONG, Yongin-si (KR); Hong-Rak SON, Anyang-si (KR); Sang-Yong YOON, Seoul (KR)

(73) Assignee: SAMSUNG ELECTRONICS CO., LTD., Suwon-si (KR)

(21) Appl. No.: 13/615,889

(22) Filed: Sep. 14, 2012

(30) Foreign Application Priority Data
Nov. 23, 2011 (KR) 10-2011-0122837

(51) Int. Cl. G06F 12/00

(52) U.S. Cl. 711/103; 711/E12.008

(57) ABSTRACT

A method of programming a nonvolatile memory device including a page buffer is provided. The method includes loading first page data and second page data into the page buffer; performing, by the page buffer, a first selective dump operation on the first page data and the second page data to generate first interleaved page data; performing, by the page buffer, a second selective dump operation on the first page data and the second page data to generate second interleaved page data; and programming the first interleaved page data and the second interleaved page data into a multi-level cell block.

### CROSS-REFERENCE TO RELATED APPLICATIONS

This application claims priority from Korean Patent Application No. 2011-0122837 filed on Nov. 23, 2011 in the Korean Intellectual Property Office (KIPO), the entire content of which is incorporated by reference herein in its entirety.

### BACKGROUND

1. Field

Exemplary embodiments relate to nonvolatile memory devices. More particularly, exemplary embodiments relate to methods of programming nonvolatile memory devices including multi-level cells.

2. Description of the Related Art

Memory cells of a nonvolatile memory device, such as a flash memory device, may be classified into single level cells (SLCs) that store one bit of data per memory cell and multi-level cells (MLCs) that store more than one bit of data per memory cell. The MLCs may store multiple bits of data by using multiple threshold voltage distributions to represent different states of multi-bit data. For example, two-bit MLCs may use four threshold voltage distributions to represent respective logical states “11”, “10”, “01” and “00”.

In a nonvolatile memory device including the MLCs, a bit error rate (BER) for a most significant bit (MSB) page is typically higher than a BER for a least significant bit (LSB) page or a center significant bit (CSB) page. Accordingly, since a size of an error correction code (ECC) is determined based on the BER for the MSB page, a memory controller for the nonvolatile memory device including the MLCs may have a large ECC overhead.

### SUMMARY

It is an aspect to provide a method of programming a nonvolatile memory device capable of interleaving page data using a page buffer unit.

According to an aspect of an exemplary embodiment, there is provided a method of programming a nonvolatile memory device including a page buffer unit, the method comprising loading first page data and second page data into the page buffer unit; performing, by the page buffer unit, a first selective dump operation on the first page data and the second page data to generate first interleaved page data; performing, by the page buffer unit, a second selective dump operation on the first page data and the second page data to generate second interleaved page data; and programming the first interleaved page data and the second interleaved page data into a multi-level cell block cell block.

In some exemplary embodiments, the page buffer unit may include first data latches, second data latches and sensing latches. To perform the first selective dump operation, the first page data may be written to the sensing latches, odd-numbered bits of the first page data may be dumped from the sensing latches to odd-numbered latches of the first data latches by the sensing latches, the second page data may be written to the sensing latches, and even-numbered bits of the second page data may be dumped from the sensing latches to even-numbered latches of the first data latches by the sensing latches.

In some exemplary embodiments, to perform the second selective dump operation, the second page data may be written to the sensing latches, odd-numbered bits of the second page data may be dumped from the sensing latches to odd-numbered latches of the second data latches by the sensing latches, the first page data may be written to the sensing latches, and even-numbered bits of the first page data may be dumped from the sensing latches to even-numbered latches of the second data latches by the sensing latches.

In some exemplary embodiments, to load the first page data and the second page data into the page buffer unit, the first page data may be loaded from a memory controller to first data latches included in the page buffer unit, and the second page data may be loaded from the memory controller to second data latches included in the page buffer unit.

In some exemplary embodiments, the first page data and the second page data provided from a memory controller may be programmed into a first page and a second page, respectively of a single level cell block. To load the first page data and the second page data into the page buffer unit, the first page data may be loaded from the first page of the single level cell block to first data latches included in the page buffer unit, and the second page data may be loaded from the second page of the single level cell block to second data latches included in the page buffer unit.

In some exemplary embodiments, to program the first interleaved page data and the second interleaved page data into the multi-level cell block, a least significant bit (LSB) program operation that programs multi-level cells included in the multi-level cell block to threshold voltage states corresponding to LSBs based on the first interleaved page data performed, and a most significant bit (MSB) program operation that programs the multi-level cells to threshold voltage states corresponding to MSBs based on the second interleaved page data may be performed.

In some exemplary embodiments, to program the first interleaved page data and the second interleaved page data into the multi-level cell block, a pre-program operation that programs multi-level cells included in the multi-level cell block to first threshold voltage states based on the first interleaved page data and the second interleaved page data may be performed, and a reprogram operation that programs the multi-level cells to second threshold voltage states narrower than the first threshold voltage states based on the first interleaved page data and the second interleaved page data may be performed.

In some exemplary embodiments, the first page data may be least significant bit page data, and the second page data may be most significant bit page data.

According to another aspect of an exemplary embodiment, there is provided a method of programming a nonvolatile memory device including a page buffer unit, the method comprising loading first page data and second page data into the page buffer unit; performing, by the page buffer unit, a first masking operation on the first page data and the second page data using first pattern data and second pattern data, respectively, to generate first interleaved page data; performing, by the page buffer unit, a second masking operation on the first page data and the second page data using the second pattern data and the first pattern data, respectively, to generate second interleaved page data; and programming the first interleaved page data and the second interleaved page data into a multi-level cell block.

In some exemplary embodiments, to perform the first masking operation, first masked page data may be generated by performing a bitwise AND operation on the first page data and the first pattern data, second masked page data may be generated by performing a bitwise AND operation on the second page data and the second pattern data, and the first interleaved page data may be generated by performing a bitwise OR operation on the first masked page data and the second masked page data.

In some exemplary embodiments, to perform the second masking operation, third masked page data may be generated by performing a bitwise AND operation on the first page data and the second pattern data, fourth masked page data may be generated by performing a bitwise AND operation on the second page data and the first pattern data, and the second interleaved page data may be generated by performing a bitwise OR operation on the third masked page data and the fourth masked page data.

In some exemplary embodiments, each bit of the second pattern data may have an opposite value to a corresponding bit of the first pattern data.

In some exemplary embodiments, odd-numbered bits of the first pattern data may have values of 1, and even-numbered bits of the first pattern data may have values of 0. Odd-numbered bits of the second pattern data may have values of 0, and even-numbered bits of the first pattern data may have values of 1.

In some exemplary embodiments, third page data may be loaded into the page buffer unit, and a third masking operation may be performed to generate third interleaved page data. The first masking operation, the second masking operation and the third masking operation may be performed using the first pattern data, the second pattern data and third pattern data. The first pattern data, the second pattern data and the third pattern data may include bits of 1 at different bit positions from one another.

In some exemplary embodiments, 3M+1-th bits of the first pattern data may have values of 1, 3M+2-th bits of the second pattern data may have values of 1, and 3M+3-th bits of the third pattern data may have values of 1, where M is an integer greater than or equal to 0.

### BRIEF DESCRIPTION OF THE DRAWINGS

Illustrative, non-limiting exemplary embodiments will be more clearly understood from the following detailed description taken in conjunction with the accompanying drawings, in which:

FIG. 1 is a flow chart illustrating a method of programming a nonvolatile memory device according to an exemplary embodiment;

FIG. 2 is a diagram for describing an example of a first selective dump operation in a program method of FIG. 1;

FIG. 3 is a flow chart illustrating an example of a first selective dump operation in a program method of FIG. 1;

FIGS. 4A through 4E are diagrams illustrating an example of a first selective dump operation of FIG. 3;

FIG. 5 is a diagram for describing an example of a second selective dump operation in a program method of FIG. 1;

FIG. 6 is a flow chart illustrating an example of a second selective dump operation in a program method of FIG. 1;

FIGS. 7A through 7E are diagrams illustrating an example of a second selective dump operation of FIG. 6;

FIGS. 8A through 8F are diagrams illustrating an example of first and second selective dump operations in a program method of FIG. 1;

FIG. 9 is a diagram illustrating an example of a program operation in a program method of FIG. 1;

FIG. 10 is a diagram illustrating another example of a program operation in a program method of FIG. 1;

FIG. 11 is a flow chart illustrating a method of reading data in a nonvolatile memory device according to an exemplary embodiment;

FIG. 12 is a diagram for describing an example of a third selective dump operation in a read method of FIG. 11;

FIG. 13 is a diagram for describing an example of a fourth selective dump operation in a read method of FIG. 11;

FIG. 14 is a block diagram illustrating an example of a memory system including a nonvolatile memory device according to exemplary embodiments;

FIG. 15 is a block diagram illustrating another example of a memory system including a nonvolatile memory device according to an exemplary embodiment;

FIG. 16 is a flow chart illustrating a method of programming a nonvolatile memory device according to an exemplary embodiment;

FIG. 17 is a diagram for describing an example of a first masking operation in a program method of FIG. 16;

FIG. 18 is a diagram for describing an example of a second masking operation in a program method of FIG. 16;

FIG. 19 is a diagram for describing an example of masking operations in a method of programming a nonvolatile memory device including memory cells that store three bits of data per memory cell;

FIG. 20 is a flow chart illustrating a method of reading data in a nonvolatile memory device according to an exemplary embodiment;

FIG. 21 is a diagram for describing an example of third and fourth masking operations in a read method of FIG. 20;

FIG. 22 is a block diagram illustrating an example of a nonvolatile memory device according to an exemplary embodiment;

FIG. 23 is a flow chart illustrating a method of programming a nonvolatile memory device according to an exemplary embodiment;

FIG. 24 is a diagram illustrating an example of first interleaved page data to be programmed by a program method of FIG. 23;

FIG. 25 is a diagram illustrating an example of second interleaved page data to be programmed by a program method of FIG. 23;

FIG. 26 is a flow chart illustrating a method of reading data in a nonvolatile memory device according to an exemplary embodiment;

FIG. 27 is a diagram illustrating an example of first page data to be output by a read method of FIG. 26;

FIG. 28 is a diagram illustrating an example of second page data to be output by a read method of FIG. 26;

FIG. 29 is a block diagram illustrating a memory system according to an exemplary embodiment;

FIG. 30 is a diagram illustrating a memory card including a memory system according to an exemplary embodiment;

FIG. 31 is a diagram illustrating a solid state drive including a memory system according to an exemplary embodiment;

FIG. 32 is a diagram illustrating a computing system according to an exemplary embodiment.

### DETAILED DESCRIPTION

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments are described herein with reference to cross-sectional illustrations that are schematic illustrations of idealized exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at edges of the implanted region rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

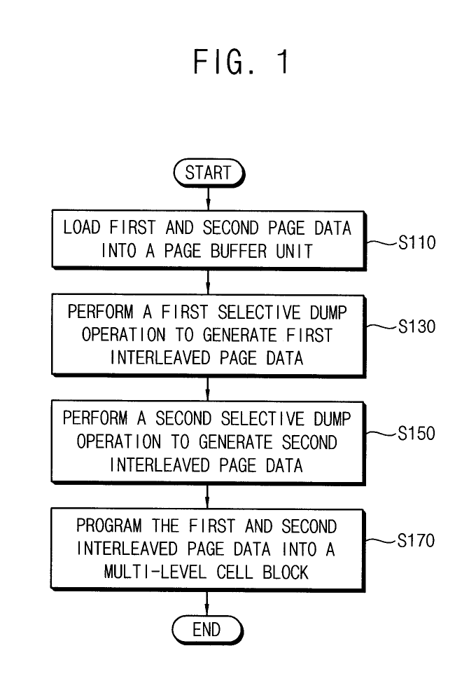

FIG. 1 is a flow chart illustrating a method of programming a nonvolatile memory device according to an exemplary embodiment.

Referring to FIG. 1, a nonvolatile memory device may load first page data and second page data into a page buffer unit (S110). The first page data and the second page data may be data for one multi-level cell page included in a multi-level cell block of the nonvolatile memory device. For example, the first page data may be least significant bit (LSB) page data for the multi-level cell page, and the second page data may be most significant page (MSB) page data for the multi-level cell page.

In some exemplary embodiments, the first page data and the second page data may be loaded from a memory controller into the page buffer unit. For example, the first page data may be loaded from the memory controller into first data latches (e.g., LSB data latches) included in the page buffer unit, and the second page data may be loaded from the memory controller into second data latches (e.g., MSB data latches) included in the page buffer unit.

In other exemplary embodiments, the nonvolatile memory device may further include a single level cell block, and may perform an on-chip buffered (OBP) program that uses the single level cell block as a buffer. For example, when the first page data and the second page data are provided from the memory controller, the nonvolatile memory device may program the first page data and the second page data into a first page and a second page of the single level cell block, respectively. Thereafter, the nonvolatile memory device may load the first page data from the first page of the single level cell block into the first data latches of the page buffer unit, and may load the second page data from the second page of the single level cell block into the second data latches of the page buffer unit.

The page buffer unit may perform a first selective dump operation on the first page data and the second page data to generate first interleaved page data including odd-numbered bits of the first page data and even-numbered bits of the second page data (S130). Sensing latches included in the page buffer unit may have a selective dump function that selectively dumps either odd-numbered bits or even-numbered bits of data stored in the sensing latches. For example, the sensing latches may write (e.g., copy or move) odd-numbered bits of data stored in the sensing latches (which may be referred to as odd column data) to odd-numbered data latches (which may be referred to as odd column data latches), or may write (e.g., copy or move) even-numbered bits of data stored in the sensing latches (which may be referred to as even column data) to even-numbered data latches (which may be referred to as even column data latches).

For example, the page buffer unit may write the first page data to the sensing latches, and the sensing latches may dump odd-numbered bits of the first page data from odd-numbered sensing latches to odd-numbered data latches of the first data latches included in the page buffer unit. Further, the page buffer unit may write the second page data to the sensing latches, and the sensing latches may dump even-numbered bits of the second page data from even-numbered sensing latches to even-numbered data latches of the first data latches included in the page buffer unit. Accordingly, the odd-numbered bits of the first page data and the even-numbered bits of the second page data, i.e., the first interleaved page data, may be stored in the first data latches.

The page buffer unit may perform a second selective dump operation on the first page data and the second page data to generate second interleaved page data including odd-numbered bits of the second page data and even-numbered bits of the first page data (S150). For example, the page buffer unit may write the second page data to the sensing latches, and the sensing latches may dump odd-numbered bits of the second page data from the odd-numbered sensing latches to odd-numbered data latches of the second data latches included in the page buffer unit. Further, the page buffer unit may write the first page data to the sensing latches, and the sensing latches may dump even-numbered bits of the first page data from the even-numbered sensing latches to even-numbered data latches of the second data latches included in the page buffer unit. Accordingly, the odd-numbered bits of the second page data and the even-numbered bits of the first page data, i.e., the second interleaved page data, may be stored in the second data latches.

The nonvolatile memory device may program the first interleaved page data and the second interleaved page data into the multi-level cell block (S170). According to exemplary embodiments, the nonvolatile memory device may perform a shadow program method including an LSB program operation and an MSB program operation, or may perform a reprogram method including a pre-program operation and a reprogram operation. In some exemplary embodiments, to perform the shadow program method, the nonvolatile memory device may perform the LSB program operation that programs multi-level cells included in the multi-level cell block to threshold voltage states corresponding to least significant bits based on the first interleaved page data, and may perform the MSB program operation that programs the multi-level cells to threshold voltage states corresponding to most significant bits based on the second interleaved page data. In other exemplary embodiments, to perform the reprogram method, the nonvolatile memory device may perform the pre-program operation that programs multi-level cells included in the multi-level cell block to first threshold voltage states based on the first interleaved page data and the second interleaved page data, and may perform the reprogram operation that programs the multi-level cells to second threshold voltage states narrower than the first threshold voltage states based on the first interleaved page data and the second interleaved page data.

As described above, in the method of programming the nonvolatile memory device according to exemplary embodiments, the page buffer unit may generate the first and second interleaved page data by performing the selective dump operations, and the nonvolatile memory device may program the first and second interleaved page data generated by the page buffer unit into the multi-level cell block. Accordingly, since the nonvolatile memory device performs interleaving without an additional dedicated interleaving module by using the page buffer unit having a selective dump function, the nonvolatile memory device may efficiently equalize bit error rates (BERs) of the page data with a small size.

The method of programming the nonvolatile memory device according to exemplary embodiments may be applied to a nonvolatile memory device including multi-level cells that store two or more bits of data per memory cell. For example, in a case of a nonvolatile memory device including multi-level cells that store two bits of data per memory cell, the nonvolatile memory device may interleave LSB page data and MSB page data by performing the selective dump operations. In other examples, in a case of a nonvolatile memory device including multi-level cells that store three bits of data per memory cell, the nonvolatile memory device may interleave LSB page data and MSB page data, or may interleave center significant bit (CSB) page data and the MSB page data. Accordingly, since the MSB page data having a relatively high BER is interleaved with the LSB page data or the CSB page data having a relatively low BER, the BERs may become substantially uniform, and an overhead for error correction by the memory controller may be reduced.

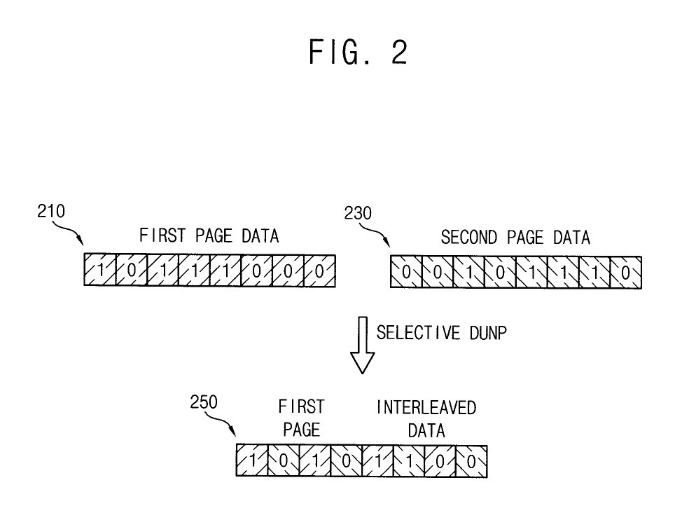

FIG. 2 is a diagram for describing an example of a first selective dump operation in a program method of FIG. 1.

Referring to FIG. 2, first page data 210 and second page data 230 may be loaded into a page buffer unit, and the page buffer unit may generate first interleaved page data 250 by performing a first selective dump operation on the first page data 210 and the second page data 230. The first selective dump operation may include a dump operation that writes a portion of bits of the first page data 210 to a portion of first data latches (e.g., LSB data latches) included in the page buffer unit, and a dump operation that writes a portion of bits of the second page data 230 to the remaining portion of the first data latches. For example, the page buffer unit may write the first page data 210 to sensing latches included in the page buffer unit, and the sensing latches may perform a dump operation that writes (e.g., copies or moves) odd-numbered bits of the first page data 210 to odd-numbered data latches of the first data latches. Further, the page buffer unit may write the second page data 230 to the sensing latches, and the sensing latches may perform a dump operation that writes (e.g., copies or moves) even-numbered bits of the second page data 230 to even-numbered data latches of the first data latches. Accordingly, the odd-numbered bits of the first page data 210 and the even-numbered bits of the second page data 230 may be stored as the first interleaved page data 250 in the first data latches.

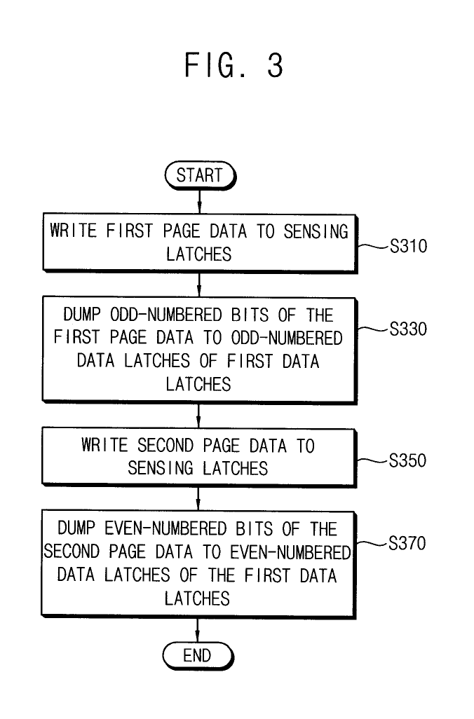

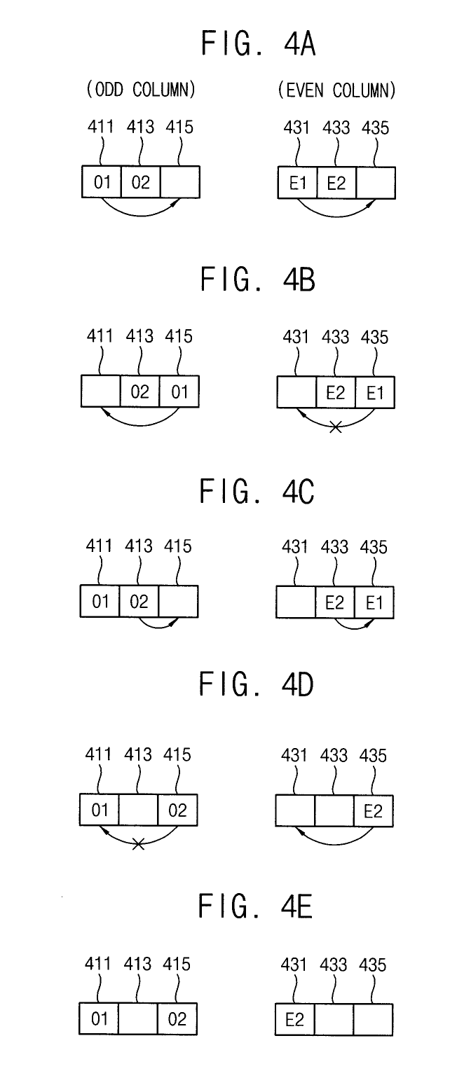

FIG. 3 is a flow chart illustrating an example of a first selective dump operation in a program method of FIG. 1, and FIGS. 4A through 4E are diagrams illustrating an example of a first selective dump operation of FIG. 3.

In FIGS. 4A through 4E, 411 represents an odd-numbered (or odd column) data latch of first data latches included in a page buffer unit, 413 represents an odd-numbered (or odd column) data latch of second data latches included in the page buffer unit, 415 represents an odd-numbered one of sensing latches included in the page buffer unit, 431 represents an even-numbered (or even column) data latch of the first data latches included in the page buffer unit, 433 represents an even-numbered (or even column) data latch of the second data latches included in the page buffer unit, and 435 represents an even-numbered one of the sensing latches included in the page buffer unit.

Referring to FIG. 4A, the page buffer unit may include the first data latches 411 and 431, the second data latches 413 and 433, and the sensing latches 415 and 435. First page data (i.e., 01 and E1) (e.g., LSB page data) may be loaded into the first data latches 411 and 431 (e.g., LSB data latches) respectively, and second page data (i.e., 02 and E2) (e.g., MSB page data) may be loaded into the second data latches 413 and 433 (e.g., MSB data latches) respectively.

Referring to FIGS. 3 and 4B, the page buffer unit may write the first page data (i.e., 01 and E1) to the sensing latches 415 and 435, respectively (S310) (see also arrows in FIG. 4A). For example, the page buffer unit may copy or move the first page data (i.e., 01and E1) from the first data latches 411 and 431 to the sensing latches 415 and 435, respectively.

Referring to FIGS. 3 and 4C, the sensing latches 415 and 435 may dump odd-numbered bits 01 of the first page data (i.e., 01 and E1) to odd-numbered data latches 411 of the first data latches 411 and 431 (S330) (see also arrow on left-hand size in FIG. 4B). Thus, the odd-numbered bits 01 of the first page data (i.e., 01 and E1) may be stored in the odd-numbered data latches 411 of the first data latches 411 and 431, and even-numbered bits E1 of the first page data (i.e., 01 and E1) are not be stored in even-numbered data latches 431 of the first data latches 411 and 431 (see arrow with X in FIG. 4B).

Referring to FIGS. 3 and 4D, the page buffer unit may write the second page data (i.e., 02 and E2) to the sensing latches 415 and 435, respectively (S350) (see also arrows in FIG. 4C). For example, the page buffer unit may copy or move the second page data (i.e., 02 and E2) from the second data latches 413 and 433 to the sensing latches 415 and 435, respectively.

Referring to FIGS. 3 and 4E, the sensing latches 415 and 435 may dump even-numbered bits E2 of the second page data (i.e., 02 and E2) to even-numbered data latches 431 of the first data latches 411 and 431 (S370) (see also arrow in FIG. 4D). Thus, odd-numbered bits 02 of the second page data (i.e., 02 and E2) are not be stored in the odd-numbered data latches 411 of the first data latches 411 and 431 (see also arrow with X on left-hand side of FIG. 4D), and the even-numbered bits E2 of the second page data (i.e., 02 and E2) may be stored in the even-numbered data latches 431 of the first data latches 411 and 431. Accordingly, the first data latches 411 and 431 may store first interleaved page data including the odd-numbered bits 01 of the first page data (i.e., 01 and E1) and the even-numbered bits E2 of the second page data (i.e., 02 and E2).

As described above, the page buffer unit may perform a first selective dump operation that generates the first interleaved page data by using the sensing latches 415 and 435 having a selective dump function.

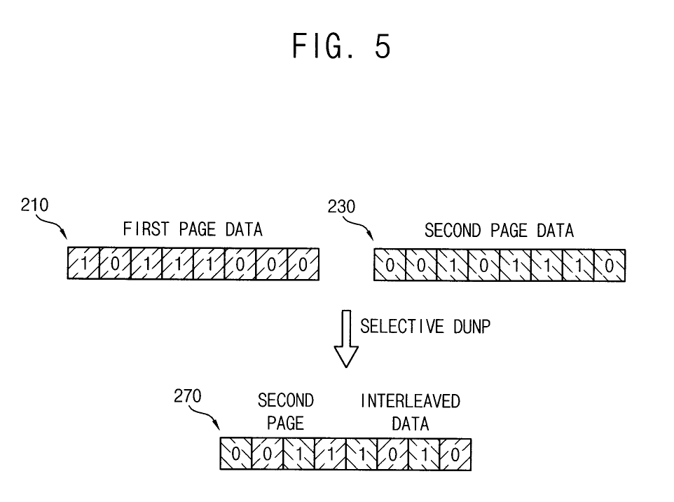

FIG. 5 is a diagram for describing an example of a second selective dump operation in a program method of FIG. 1.

Referring to FIG. 5, first page data 210 and second page data 230 may be loaded into a page buffer unit, and the page buffer unit may generate second interleaved page data 270 by performing a second selective dump operation on the first page data 210 and the second page data 230. The second selective dump operation may include a dump operation that writes a portion of bits of the first page data 210 to a portion of second data latches (e.g., MSB data latches) included in the page buffer unit, and a dump operation that writes a portion of bits of the second page data 330 to the remaining portion of the second data latches. For example, the page buffer unit may write the second page data 230 to sensing latches included in the page buffer unit, and the sensing latches may perform a dump operation that writes (e.g., copies or moves) odd-numbered bits of the second page data 230 to odd-numbered data latches of the second data latches. Further, the page buffer unit may write the first page data 210 to the sensing latches, and the sensing latches may perform a dump operation that writes (e.g., copies or moves) even-numbered bits of the first page data 210 to even-numbered data latches of the second data latches. Accordingly, the odd-numbered bits of the second page data 230 and the even-numbered bits of the first page data 210 may be stored as the second interleaved page data 270 in the second data latches.

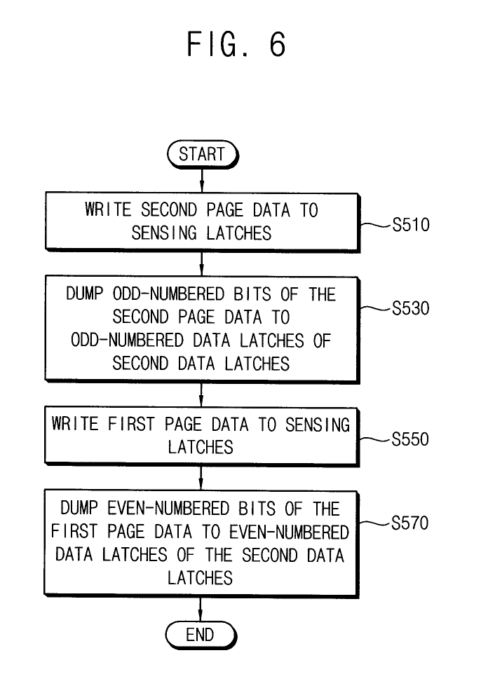

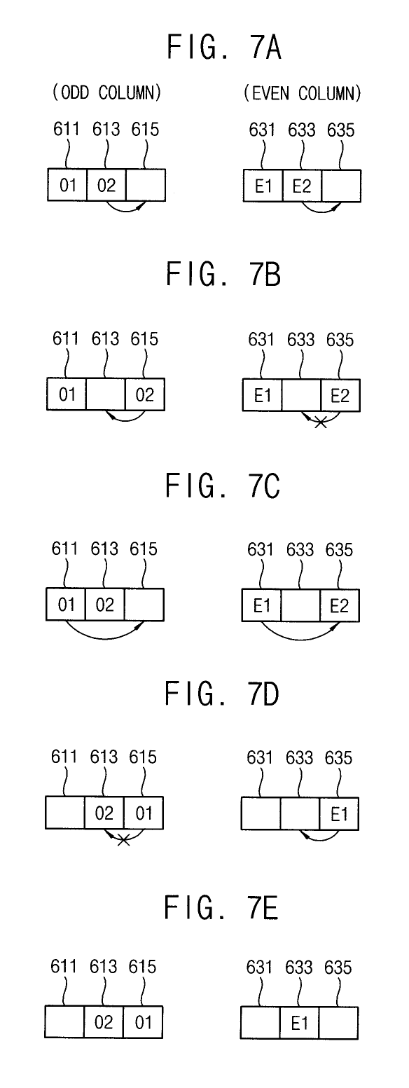

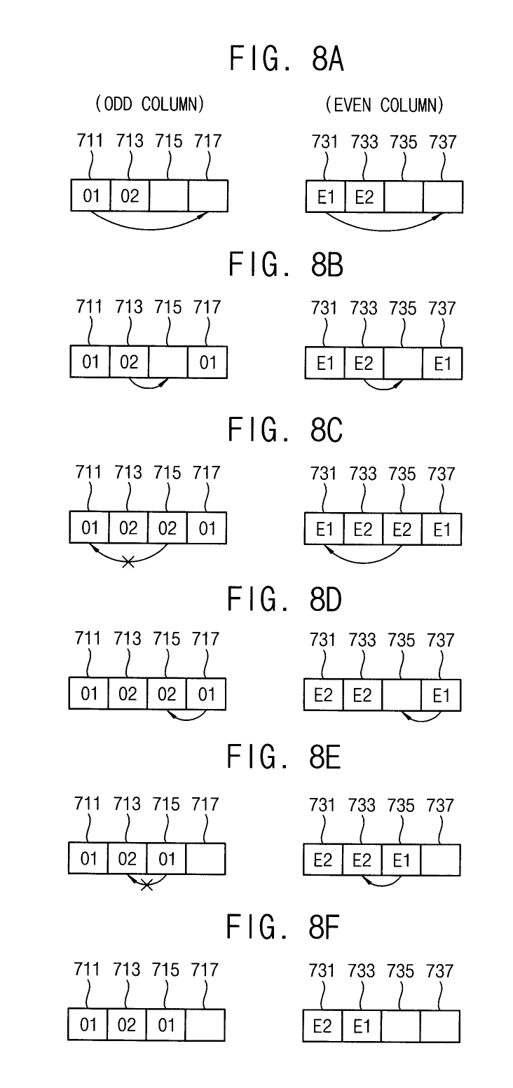

FIG. 6 is a flow chart illustrating an example of a second selective dump operation in a program method of FIG. 1, and FIGS. 7A through 7E are diagrams illustrating an example of a second selective dump operation of FIG. 6.

In FIGS. 7A through 7E, 611 represents an odd-numbered (or odd column) data latch of first data latches included in a page buffer unit, 613 represents an odd-numbered (or odd column) data latch of second data latches included in the page buffer unit, 615 represents an odd-numbered one of sensing latches included in the page buffer unit, 631 represents an even-numbered (or even column) data latch of the first data latches included in the page buffer unit, 633 represents an even-numbered (or even column) data latch of the second data latches included in the page buffer unit, and 635 represents an even-numbered one of the sensing latches included in the page buffer unit.

Referring to FIG. 7A, first page data (i.e., 01 and E1) (e.g., LSB page data) may be loaded into the first data latches 611 and 631 respectively (e.g., LSB data latches), and second page data (i.e., 02 and E2) (e.g., MSB page data) may be loaded into the second data latches 613 and 633 respectively (e.g., MSB data latches).

Referring to FIGS. 6 and 7B (and also the arrows in FIG. 7A), the page buffer unit may write the second page data (i.e., 02 and E2) to the sensing latches 615 and 635 (S510). For example, the page buffer unit may copy or move the second page data (i.e., 02 and E2) from the second data latches 613 and 633 to the sensing latches 615 and 635, respectively.

Referring to FIGS. 6 and 7C (and also the arrows in FIG. 7B), the sensing latches 615 and 635 may dump odd-numbered bits 02 of the second page data (i.e., 02 and E2) to odd-numbered data latches 613 of the second data latches 613 and 633 (S530). Thus, the odd-numbered bits 02 of the second page data (i.e., 02 and E2) may be stored in the odd-numbered data latches 613 of the second data latches 613 and 633, and even-numbered bits E2 of the second page data (i.e., 02 and E2) are not be stored in even-numbered data latches 633 of the second data latches 613 and 633.

Referring to FIGS. 6 and 7D (and also arrows in FIG. 7C), the page buffer unit may write the first page data (i.e., 01 and E1) to the sensing latches 615 and 635 respectively (S550). For example, the page buffer unit may copy or move the first page data (i.e., 01 and E1) from the first data latches 611 and 631 to the sensing latches 615 and 635, respectively.

Referring to FIGS. 6 and 7E (and also arrows in FIG. 7D), the sensing latches 615 and 635 may dump even-numbered bits El of the first page data (i.e., 01 and E1) to even-numbered data latches 633 of the second data latches 613 and 633 (S570). Thus, odd-numbered bits 01 of the first page data (i.e., 01 and E1) are not be stored in the odd-numbered data latches 613 of the second data latches 613 and 633, and the even-numbered bits E1 of the first page data (i.e., 01 and E1) may be stored in the even-numbered data latches 633 of the second data latches 631 and 633. Accordingly, the second data latches 613 and 633 may store second interleaved page data including the odd-numbered bits 02 of the second page data (i.e., 01 and E2) and the even-numbered bits E1 of the first page data (i.e., 01 and E1).

As described above, the page buffer unit may perform a second selective dump operation that generates the second interleaved page data by using the sensing latches 615 and 635 having a selective dump function.

FIGS. 8A through 8F are diagrams illustrating an example of first and second selective dump operations in a program method of FIG. 1.

In FIGS. 8A through 8F, 711 represents an odd-numbered (or odd column) data latch of first data latches included in a page buffer unit, 713 represents an odd-numbered (or odd column) data latch of second data latches included in the page buffer unit, 715 represents an odd-numbered one of sensing latches included in the page buffer unit, 717 represents an odd-numbered one of cache latches included in the page buffer unit, 731 represents an even-numbered (or even column) data latch of the first data latches included in the page buffer unit, 733 represents an even-numbered (or even column) data latch of the second data latches included in the page buffer unit, 735 represents an even-numbered one of the sensing latches included in the page buffer unit, and 737 represents an even-numbered one of the cache latches included in the page buffer unit.

Referring to FIG. 8A, first page data (i.e., 01 and E1) (e.g., LSB page data) may be loaded into the first data latches 711 and 731 respectively (e.g., LSB data latches), and second page data (i.e., 02 and E2) (e.g., MSB page data) may be loaded into the second data latches 713 and 733 respectively (e.g., MSB data latches).

Referring to FIG. 8B (and also arrows in FIG. 8A), the page buffer unit may copy the first page data (i.e., 01 and E1) from the first data latches 711 and 731 to the cache latches 717 and 737, respectively.

Referring to FIG. 8C (and also arrows in FIG. 8B), the page buffer unit may copy or move the second page data (i.e., 02 and E2) from the second data latches 713 and 733 to the sensing latches 715 and 735, respectively.

Referring to FIG. 8D (and also arrows in FIG. 8C), the sensing latches 715 and 735 may perform a selective dump operation that writes even-numbered bits E2 of the second page data (i.e., 02 and E2) to even-numbered data latches 731 of the first data latches 711 and 731. Accordingly, odd-numbered bits 01 of the first page data (i.e., 01 and E1) may be stored in odd-numbered data latches 711 of the first data latches 711 and 731, and even-numbered bits E2 of the second page data (i.e., 02 and E2) may be stored in even-numbered data latches 731 of the first data latches 711 and 731. That is, the first data latches 711 and 731 may store first interleaved page data including the odd-numbered bits 01 of the first page data (i.e., 01 and E1) and the even-numbered bits E2 of the second page data (i.e., 02 and E2).

Referring to FIG. 8E (and also arrows in FIG. 8D), the page buffer unit may copy or move the first page data (i.e., 01 and E1) from the cache latches 717 and 737 to the sensing latches 715 and 735, respectively.

Referring to FIG. 8F (and also arrows in FIG. 8E), the sensing latches 715 and 735 may perform a selective dump operation that writes even-numbered bits E1 of the first page data (i.e., 01 and E1) to even-numbered data latches 733 of the second data latches 713 and 733. Accordingly, odd-numbered bits 02 of the second page data (i.e., 02 and E2) may be stored in odd-numbered data latches 713 of the second data latches 713 and 733, and even-numbered bits E1 of the first page data (i.e., 01 and E1) may be stored in even-numbered data latches 733 of the second data latches 713 and 733. That is, the second data latches 713 and 733 may store second interleaved page data including the odd-numbered bits 02 of the second page data (i.e., 02 and E2) and the even-numbered bits El of the first page data (i.e., 01 and E1).

As described above, the page buffer unit may perform the selective dump operations that generate the first interleaved page data and the and second interleaved page data by using the sensing latches 715 and 735 having a selective dump function and the cache latches 717 and 737.

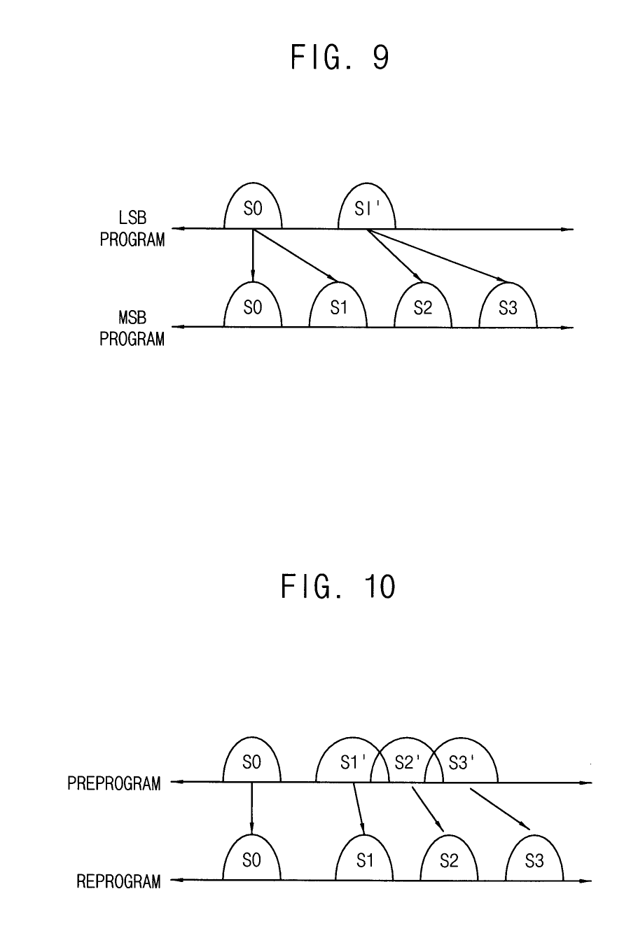

FIG. 9 is a diagram illustrating an example of a program operation in a program method of FIG. 1.

Referring to FIG. 9, a nonvolatile memory device according to exemplary embodiments may program first interleaved page data and second interleaved page data to a multi-level cell page of a multi-level cell block using a shadow program method. For example, the nonvolatile memory device may perform an LSB program operation that programs multi-level cells included in the multi-level cell page to have threshold voltage states SO and SF corresponding to N-th bits (e.g., least significant bits) based on the first interleaved page data, where N is an integer greater than 0. After the LSB program operation, the nonvolatile memory device may perform an MSB program operation that programs the multi-level cells to have threshold voltage states S0, S1, S2 and S3 corresponding to N+1-th bits (e.g., most significant bits) based on the second interleaved page data.

FIG. 10 is a diagram illustrating another example of a program operation in a program method of FIG. 1.

Referring to FIG. 10, a nonvolatile memory device according to exemplary embodiments may program first interleaved page data and second interleaved page data to a multi-level cell page of a multi-level cell block using a reprogram method. For example, the nonvolatile memory device may perform a pre-program operation that programs multi-level cells included in the multi-level cell page to have first threshold voltage states S0, S1′, S2′ and S3′ based on the first interleaved page data and the second interleaved page data. After the pre-program operation, the nonvolatile memory device may perform a reprogram operation that programs the multi-level cells to have second threshold voltage states S0, S1, S2 and S3 narrower than the first threshold voltage states S0, S1′, S2′ and S3′ based on the first interleaved page data and the second interleaved page data.

Although FIGS. 9 and 10 illustrate examples of program operations of nonvolatile memory devices including multi-level cells that store two bits of data per memory cell, a method of programming a nonvolatile memory device according to exemplary embodiments may also be applied to a nonvolatile memory device including multi-level cells that store three or more bits of data per memory cell.

For example, in a case of a nonvolatile memory device including multi-level cells that store three bits of data per memory cell, the method of programming the nonvolatile memory device according to exemplary embodiments may interleave LSB page data and MSB page data by performing a selective dump operation, or may interleave CSB page data and MSB page data by performing a selective dump operation. In a case of a nonvolatile memory device including multi-level cells that store four bits of data per memory cell, the method of programming the nonvolatile memory device according to exemplary embodiments may interleave MSB page data and another page data. In this case, the remaining two page data may be programmed to a multi-level cell block after being interleaved with each other or without being interleaved.

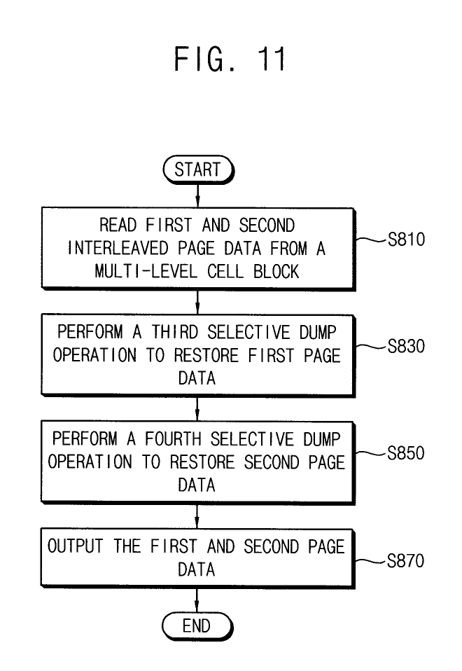

FIG. 11 is a flow chart illustrating a method of reading data in a nonvolatile memory device according to exemplary embodiments.

Referring to FIG. 11, a nonvolatile memory device may read first interleaved page data and second interleaved page data from a multi-level cell block to a page buffer unit (S810).

The page buffer unit may restore first page data by performing a third selective dump operation on the first interleaved page data and the second interleaved page data (S830). For example, the page buffer unit may write odd-numbered bits of the first interleaved page data and even-numbered bits of the second interleaved page data to first data latches (e.g., LSB data latches) included in the page buffer unit by performing the third selective dump operation. Accordingly, the first data latches may store the first page data including the odd-numbered bits of the first interleaved page data and the even-numbered bits of the second interleaved page data.

The page buffer unit may restore second page data by performing a fourth selective dump operation on the first interleaved page data and the second interleaved page data (S850). For example, the page buffer unit may write odd-numbered bits of the second interleaved page data and even-numbered bits of the first interleaved page data to second data latches (e.g., MSB data latches) included in the page buffer unit by performing the fourth selective dump operation. Accordingly, the second data latches may store the second page data including the odd-numbered bits of the second interleaved page data and the even-numbered bits of the first interleaved page data.

The nonvolatile memory device may output the first page data and the second page data to a memory controller (S870). That is, the nonvolatile memory device may output the first page data stored in the first data latches and the second page data stored in the second data latches to the memory controller.

As described above, in a method of reading data in a nonvolatile memory device according to exemplary embodiments, the page buffer unit may perform the selective dump operations that de-interleave the first and second interleaved page data to generate or restore the first and second page data.

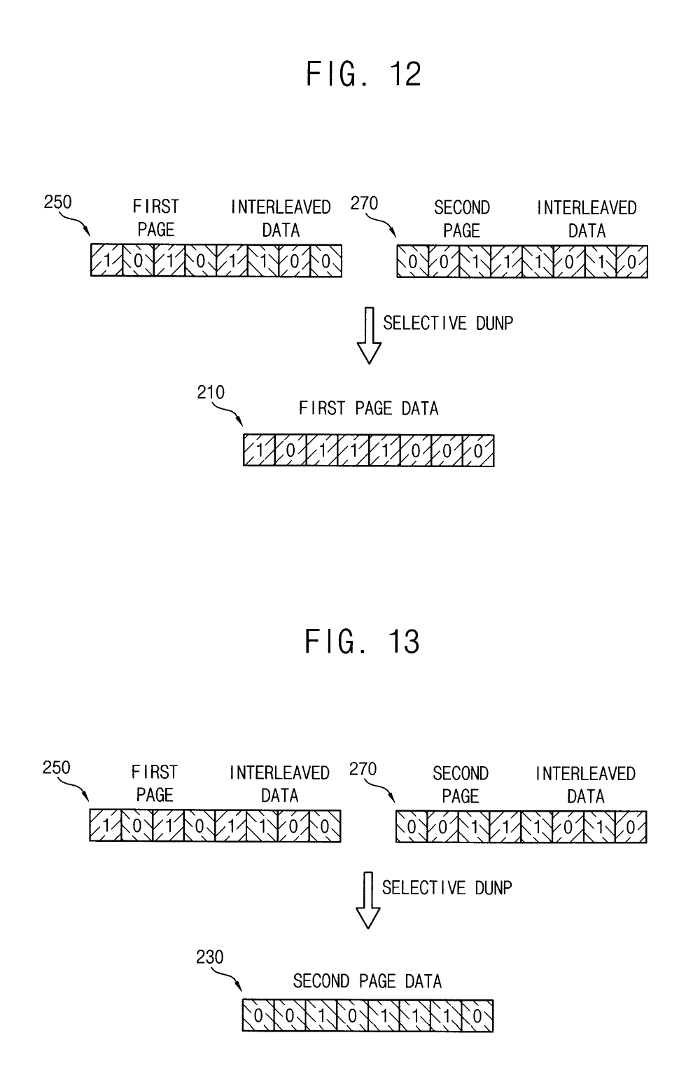

FIG. 12 is a diagram for describing an example of a third selective dump operation in a read method of FIG. 11.

Referring to FIG. 12, first interleaved page data 250 and second interleaved page data 270 may be read from a multi-level cell block to a page buffer unit, and the page buffer unit may generate or restore first page data 210 by performing a third selective dump operation on the first interleaved page data 250 and the second interleaved page data 270. The third selective dump operation may include a dump operation that writes a portion of bits of the first interleaved page data 250 to a portion of first data latches (e.g., LSB data latches) included in the page buffer unit, and a dump operation that writes a portion of bits of the second interleaved page data 270 to the remaining portion of the first data latches. For example, when the first interleaved page data 250 are read from the multi-level cell block to sensing latches included in the page buffer unit, the sensing latches may perform a dump operation that copies or moves odd-numbered bits of the first interleaved page data 250 to odd-numbered data latches of the first data latches. Further, when the second interleaved page data 270 are read from the multi-level cell block to the sensing latches, the sensing latches may perform a dump operation that copies or moves even-numbered bits of the second interleaved page data 270 to even-numbered data latches of the first data latches. Accordingly, the first data latches may store the first page data 210 including the odd-numbered bits of the first interleaved page data 250 and the even-numbered bits of the second interleaved page data 270.

FIG. 13 is a diagram for describing an example of a fourth selective dump operation in a read method of FIG. 11.

Referring to FIG. 13, first interleaved page data 250 and second interleaved page data 270 may be read from a multi-level cell block to a page buffer unit, and the page buffer unit may generate or restore second page data 230 by performing a fourth selective dump operation on the first interleaved page data 250 and the second interleaved page data 270. The fourth selective dump operation may include a dump operation that writes a portion of bits of the first interleaved page data 250 to a portion of second data latches (e.g., MSB data latches) included in the page buffer unit, and a dump operation that writes a portion of bits of the second interleaved page data 270 to the remaining portion of the second data latches. For example, when the first interleaved page data 250 are read from the multi-level cell block to sensing latches included in the page buffer unit, the sensing latches may perform a dump operation that copies or moves even-numbered bits of the first interleaved page data 250 to even-numbered data latches of the second data latches. Further, when the second interleaved page data 270 are read from the multi-level cell block to the sensing latches, the sensing latches may perform a dump operation that copies or moves odd-numbered bits of the second interleaved page data 270 to odd-numbered data latches of the second data latches. Accordingly, the second data latches may store the second page data 230 including the odd-numbered bits of the second interleaved page data 270 and the even-numbered bits of the first interleaved page data 250.

In some exemplary embodiments, the third selective dump operation illustrated in FIG. 12 and the fourth selective dump operation illustrated in FIG. 13 may be substantially simultaneously performed. For example, when the first interleaved page data 250 are read from the multi-level cell block to the sensing latches, the sensing latches may dump (e.g. copy or move) the odd-numbered bits of the first interleaved page data 250 to the odd-numbered data latches of the first data latches, and may dump the even-numbered bits of the first interleaved page data 250 to the even-numbered data latches of the second data latches. Further, when the second interleaved page data 270 are read from the multi-level cell block to the sensing latches, the sensing latches may dump the odd-numbered bits of the second interleaved page data 270 to the odd-numbered data latches of the second data latches, and may dump the even-numbered bits of the second interleaved page data 270 to the even-numbered data latches of the first data latches.

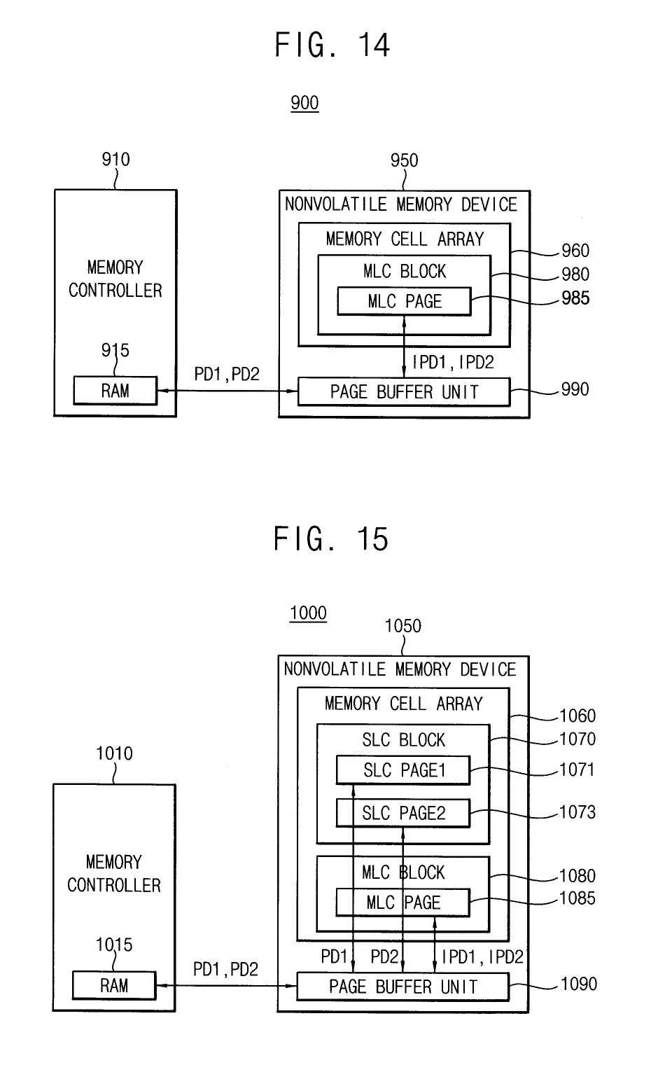

FIG. 14 is a block diagram illustrating an example of a memory system including a nonvolatile memory device according to an exemplary embodiment.

Referring to FIG. 14, a memory system 900 includes a memory controller 910 and a nonvolatile memory device 950.

The memory controller 910 may control the nonvolatile memory device 950 to store data provided from a host (not shown) or to provide the stored data to the host. The memory controller 910 may include a buffer memory 915 that temporarily store the data provided from the host or the data read from the nonvolatile memory device 950. In some exemplary embodiments, the buffer memory 915 may be implemented by a volatile memory device, such as a dynamic random access memory (DRAM), a static random access memory (SRAM), etc. According to exemplary embodiments, the buffer memory 915 may be located inside or outside the memory controller 910.

The nonvolatile memory device 950 may include a memory cell array 960 and a page buffer unit 990. The memory cell array 960 may include a multi-level cell (MLC) block 980 having multi-level cells that store two or more bits of data per memory cell. In some exemplary embodiments, the memory cell array 960 may further include a single level cell block having single level cells that store one bit of data per memory cell.

First page data PD1 and second page data PD2 may be loaded from the buffer memory 915 of the memory controller 910 into the page buffer unit 990. The page buffer unit 990 may generate first interleaved page data IPD1 and second interleaved page data IPD2 by performing selective dump operations on the first page data PD1 and the second page data PD2. For example, the page buffer unit 990 may generate the first interleaved page data IPD1 including odd-numbered bits of the first page data PD1 and even-numbered bits of the second page data PD2 by using sensing latches included in the page buffer unit 990, and may generate the second interleaved page data IPD2 including odd-numbered bits of the second page data PD2 and even-numbered bits of the first page data PD1 by using the sensing latches. The first interleaved page data IPD1 and the second interleaved page data IPD2 may be programmed to a multi-level cell page 985 of the multi-level cell block 980.

Once the memory controller 910 requests the nonvolatile memory device 950 to provide the first page data PD1 and the second page data PD2, the page buffer unit 990 may read the first interleaved page data IPD1 and the second interleaved page data IPD2 from the multi-level cell page 985 of the multi-level cell block 980. The page buffer unit 990 may generate or restore the first page data PD1 and the second page data PD2 by performing selective dump operations on the first interleaved page data IPD1 and the second interleaved page data IPD2. For example, the page buffer unit 990 may generate the first page data PD1 including odd-numbered bits of the first interleaved page data IPD1 and even-numbered bits of the second interleaved page data IPD2 by using the sensing latches, and may generate the second page data PD2 including odd-numbered bits of the second interleaved page data IPD2 and even-numbered bits of the first interleaved page data IPD1 by using the sensing latches. The first page data PD1 and the second page data PD2 generated by the page buffer unit 990 may be provided to the host via the memory controller 910.

As described above, since the nonvolatile memory device 910 according to exemplary embodiments may perform interleaving and/or de-interleaving without an additional dedicated interleaving module by using the page buffer unit 990 having a selective dump function, the nonvolatile memory device 950 may efficiently equalize bit error rates (BERs) of the page data with a small size.

FIG. 15 is a block diagram illustrating another example of a memory system including a nonvolatile memory device according to an exemplary embodiment.

Referring to FIG. 15, a memory system 1000 includes a memory controller 1010 and a nonvolatile memory device 1050.

The memory controller 1010 may control the nonvolatile memory device 1050 to store data provided from a host (not shown) or to provide the stored data to the host. The memory controller 1010 may include a buffer memory 1015 that temporarily store the data provided from the host or the data read from the nonvolatile memory device 950.

The nonvolatile memory device 1050 may include a memory cell array 1060 and a page buffer unit 1090. The memory cell array 1060 may include a single level cell (SLC) block 1070 having single level cells that store one bit of data per memory cell, and a multi-level cell (MLC) block 1080 having multi-level cells that store two or more bits of data per memory cell.

First page data PD1 and second page data PD2 may be loaded from the buffer memory 1015 of the memory controller 1010 into the page buffer unit 1090. The first page data PD1 and the second page data PD2 loaded in the page buffer unit 1090 may be programmed to a first single level cell (SLC) page 1071 and a second single level cell (SLC) page 1073 of the single level cell (SLC) block 1070, respectively. Once the first and second page data PD1 and PD2 are programmed to the first and second single level cell pages 1071 and 1073 respectively, the nonvolatile memory device 1050 may inform the memory controller 1010 that a program operation is completed. Accordingly, since the nonvolatile memory device 1050 may inform the memory controller 1010 about the completion of the program operation after a program operation for the single level cell block 1070 is performed, the memory controller 1010 need not wait for completion of a program operation for the multi-level cell block 1080, and may perform subsequent operations.

After the first and second page data PD1 and PD2 are stored in the first and second single level cell pages 1071 and 1073 respectively, the first and second page data PD1 and PD2 may be loaded again into the page buffer unit 1090. If the first and second page data PD1 and PD2 are loaded again, the page buffer unit 1090 may generate first interleaved page data IPD1 and second interleaved page data IPD2 by performing selective dump operations on the first and second page data PD1 and PD2. For example, the page buffer unit 1090 may generate the first interleaved page data IPD1 including odd-numbered bits of the first page data PD1 and even-numbered bits of the second page data PD2 by using sensing latches included in the page buffer unit 1090, and may generate the second interleaved page data IPD2 including odd-numbered bits of the second page data PD2 and even-numbered bits of the first page data PD1 by using the sensing latches. The first interleaved page data IPD1 and the second interleaved page data IPD2 generated by the page buffer unit 1090 may be programmed to a multi-level cell page 1085 of the multi-level cell block 1080.

Once the memory controller 1010 requests the nonvolatile memory device 1050 to provide the first page data PD1 and the second page data PD2, the page buffer unit 1090 may read the first interleaved page data IPD1 and the second interleaved page data IPD2 from the multi-level cell page 1085 of the multi-level cell block 1080. The page buffer unit 1090 may generate or restore the first page data PD1 and the second page data PD2 by performing selective dump operations on the first interleaved page data IPD1 and the second interleaved page data IPD2. For example, the page buffer unit 1090 may generate the first page data PD1 including odd-numbered bits of the first interleaved page data IPD1 and even-numbered bits of the second interleaved page data IPD2 by using the sensing latches, and may generate the second page data PD2 including odd-numbered bits of the second interleaved page data IPD2 and even-numbered bits of the first interleaved page data IPD1 by using the sensing latches. The first page data PD1 and the second page data PD2 generated by the page buffer unit 1090 may be provided to the host via the memory controller 1010.

As described above, since the nonvolatile memory device 1050 according to exemplary embodiments may perform interleaving and/or de-interleaving without an additional dedicated interleaving module by using the page buffer unit 1090 having a selective dump function, the nonvolatile memory device 1050 may efficiently equalize bit error rates (BERs) of the page data with a small size.

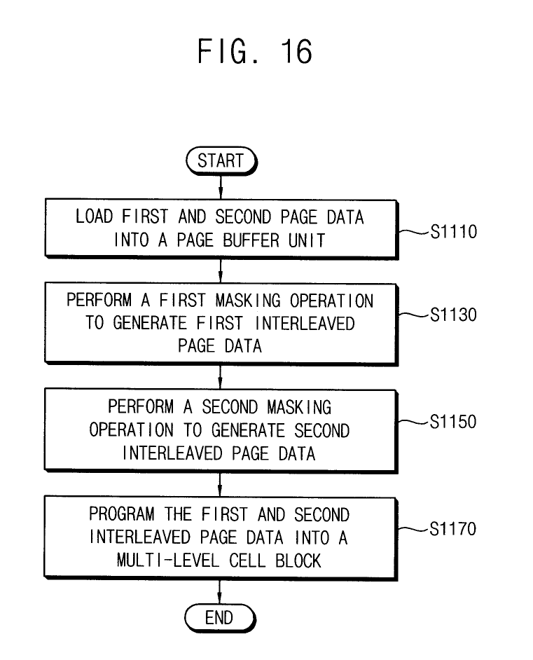

FIG. 16 is a flow chart illustrating a method of programming a nonvolatile memory device according to an exemplary embodiment.

Referring to FIG. 16, a nonvolatile memory device may load first page data and second page data into a page buffer unit (S1110). For example, the first page data may be least significant bit (LSB) page data for a multi-level cell page, and the second page data may be most significant page (MSB) page data for the multi-level cell page. According to exemplary embodiments, the first and second page data may be loaded from a memory controlled into the page buffer unit, or may be loaded from a single level cell block into the page buffer unit.

The page buffer unit may perform a first masking operation on the first page data and the second page data respectively using first pattern data and second pattern data to generate first interleaved page data (S1130). For example, the page buffer unit may generate first masked page data by performing a bitwise AND operation on the first page data and the first pattern data, and may generate second masked page data by performing a bitwise AND operation on the second page data and the second pattern data. The page buffer unit may generate the first interleaved page data by performing a bitwise OR operation on the first masked page data and the second masked page data. In some exemplary embodiments, each bit of the second pattern data may have an opposite value to a corresponding bit of the first pattern data. For example, odd-numbered bits of the first pattern data may have values of 1, and odd-numbered bits of the second pattern data may have values of 0. Further, even-numbered bits of the first pattern data may have values of 0, and even-numbered bits of the second pattern data may have values of 1. In this case, the first interleaved page data may include odd-numbered bits of the first page data and even-numbered bits of the second page data.

The page buffer unit may perform a second masking operation on the first page data and the second page data respectively using the second pattern data and the first pattern data to generate second interleaved page data (S1150). For example, the page buffer unit may generate third masked page data by performing a bitwise AND operation on the first page data and the second pattern data, and may generate fourth masked page data by performing a bitwise AND operation on the second page data and the first pattern data. The page buffer unit may generate the second interleaved page data by performing a bitwise OR operation on the third masked page data and the fourth masked page data. For example, the second interleaved page data may include odd-numbered bits of the second page data and even-numbered bits of the first page data.

The nonvolatile memory device may program the first interleaved page data and the second interleaved page data to a multi-level cell block (S1170). According to exemplary embodiments, the nonvolatile memory device may program the first and second interleaved page data to the multi-level cell block using a shadow program method or a reprogram method.

As described above, in the method of programming the nonvolatile memory device according to exemplary embodiments, the page buffer unit may generate the first and second interleaved page data by performing the masking operations, and the nonvolatile memory device may program the first and second interleaved page data generated by the page buffer unit into the multi-level cell block. Accordingly, since the nonvolatile memory device performs interleaving without an additional dedicated interleaving module by using the page buffer unit having a masking function, the nonvolatile memory device may efficiently equalize bit error rates (BERs) of the page data with a small size.

The method of programming the nonvolatile memory device according to exemplary embodiments may be applied to a nonvolatile memory device including multi-level cells that store two or more bits of data per memory cell. For example, in a case of a nonvolatile memory device including multi-level cells that store two bits of data per memory cell, the nonvolatile memory device may interleave LSB page data and MSB page data by performing the masking operations. In other examples, in a case of a nonvolatile memory device including multi-level cells that store three bits of data per memory cell, the nonvolatile memory device may interleave LSB page data and MSB page data, may interleave CSB page data and the MSB page data, or may interleave the LSB page data, the CSB page data and the MSB page data. In a case where the LSB page data, the CSB page data and the MSB page data are interleaved, the page buffer unit may use first, second and third pattern data including bits of 1 at different bit positions from one another. For example, 3M+1-th bits of the first pattern data may have values of 1, 3M+2-th bits of the second pattern data may have values of 1, and 3M+3-th bits of the third pattern data may have values of 1, where M is an integer greater than or equal to 0.

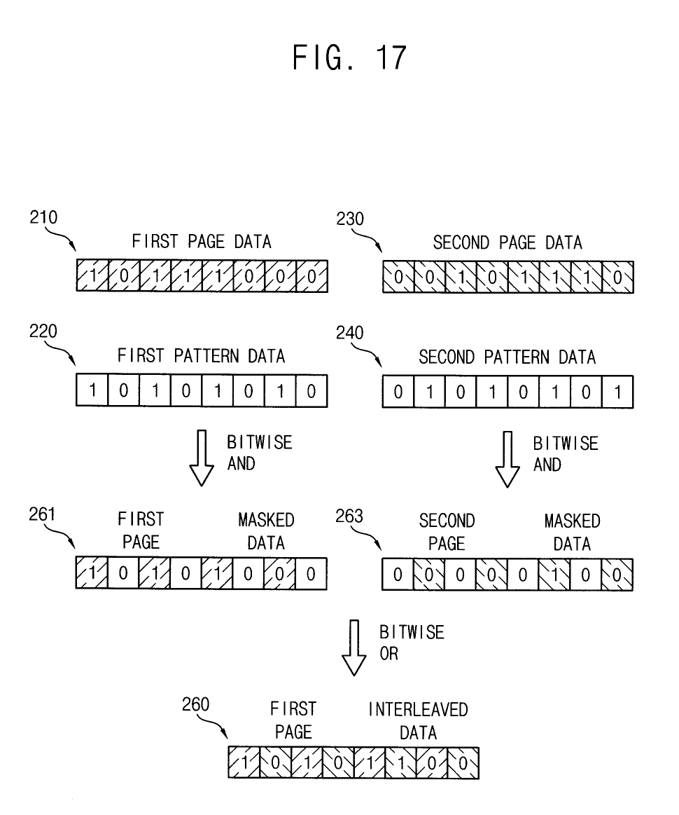

FIG. 17 is a diagram for describing an example of a first masking operation in a program method of FIG. 16.

Referring to FIG. 17, first page data 210 and second page data 230 may be loaded into a page buffer unit, and the page buffer unit may perform a first masking operation on the first page data 210 and the second page data 230 to generate first interleaved page data 260. The first masking operation may include bitwise AND operations and a bitwise OR operation using first pattern data 220 and second pattern data 240. For example, the page buffer unit may generate first masked page data 261 by performing a bitwise AND operation (or masking) on the first page data 210 and the first pattern data 220, and may generate second masked page data 263 by performing a bitwise AND operation (or masking) on the second page data 230 and the second pattern data 240. Each bit of the second pattern data 240 may have an opposite value to a corresponding bit of the first pattern data 220. For example, as illustrated in FIG. 17, odd-numbered bits of the first pattern data 220 may have values of 1, odd-numbered bits of the second pattern data 240 may have values of 0, even-numbered bits of the first pattern data 220 may have values of 0, and even-numbered bits of the second pattern data 240 may have values of 1. However, the first pattern data 220 and the second pattern data 240 are not limited to the example illustrated in FIG. 17. Rather, the first pattern data 220 and the second pattern data 240 may be any data including bits of 1 at different bit positions from each other. The number of the bits having values of 1 included in the first and second pattern data 220 and 240 may be the same as the number of bits included in one pattern data or one page data.

The page buffer unit may generate the first interleaved page data 260 by performing a bitwise OR operation on the first masked page data 261 and the second masked page data 263. For example, in a case where the odd-numbered bits of the first pattern data 220 have values of 1 and the even-numbered bits of the second pattern data 240 have values of 1, the first interleaved page data 260 may include odd-numbered bits of the first page data 210 and even-numbered bits of the second page data 230. Accordingly, the first interleaved page data 260 where the first page data 210 and the second page data 230 are interleaved may be generated.

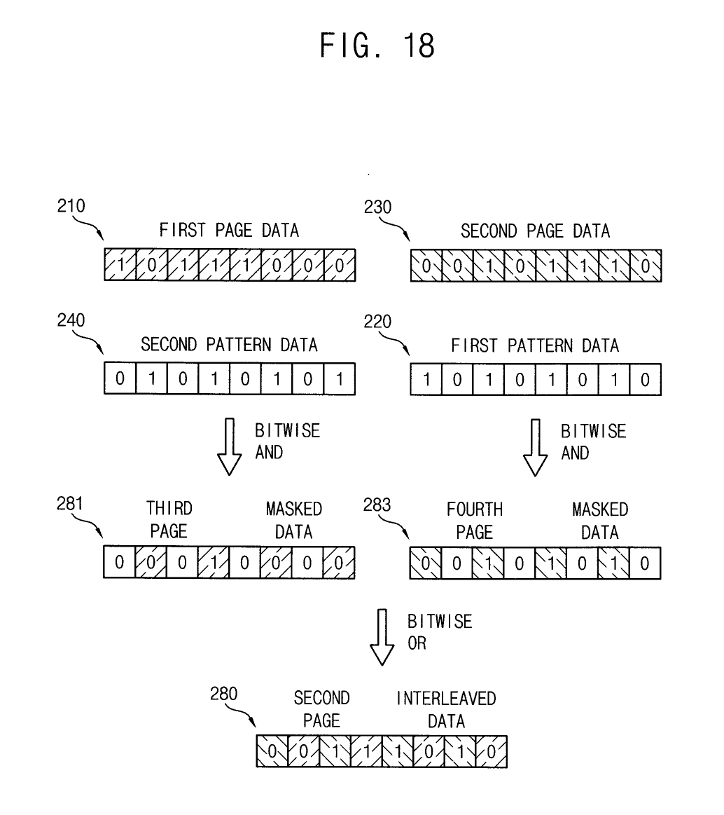

FIG. 18 is a diagram for describing an example of a second masking operation in a program method of FIG. 16.

Referring to FIG. 18, first page data 210 and second page data 230 may be loaded into a page buffer unit, and the page buffer unit may perform a second masking operation on the first page data 210 and the second page data 230 to generate second interleaved page data 280. The second masking operation may include bitwise AND operations and a bitwise OR operation using first pattern data 220 and second pattern data 240, but with an order swapped from that shown in FIG. 17. For example, the page buffer unit may generate third masked page data 281 by performing a bitwise AND operation (or masking) on the first page data 210 and the second pattern data 240, and may generate fourth masked page data 283 by performing a bitwise AND operation (or masking) on the second page data 230 and the first pattern data 220.

The page buffer unit may generate the second interleaved page data 280 by performing a bitwise OR operation on the third masked page data 281 and the fourth masked page data 283. For example, in a case where odd-numbered bits of the first pattern data 220 have values of 1 and even-numbered bits of the second pattern data 240 have values of 1, the second interleaved page data 280 may include odd-numbered bits of the second page data 230 and even-numbered bits of the first page data 210. Accordingly, the second interleaved page data 280 where the first page data 210 and the second page data 230 are interleaved may be generated.

As illustrated in FIGS. 17 and 18, the page buffer unit may generate the first interleaved page data 260 by performing the first masking operation on the first page data 210 and the second page data 230 respectively using the first pattern data 220 and the second pattern data 240, and generate the second interleaved page data 280 by performing the second masking operation on the first page data 210 and the second page data 230 respectively using the second pattern data 240 and the first pattern data 220. With respect to each page data, one pattern data may be used during the first masking operation, and inverted pattern data of which bits have opposite values to bits of the pattern data may be used during the second masking operation. Accordingly, the first interleaved page data 260 may include a portion of bits of the first page data 210 and a portion of bits of the second page data 230, and the second interleaved page data 280 may include the remaining bits of the first page data 210 and the remaining bits of the second page data 230.

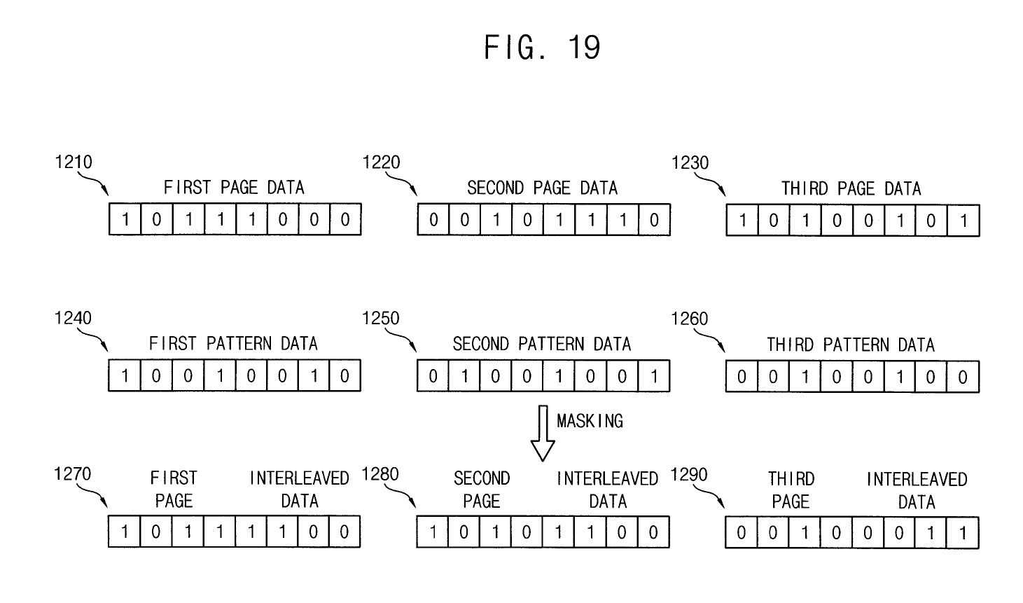

FIG. 19 is a diagram for describing an example of masking operations in a method of programming a nonvolatile memory device including memory cells that store three bits of data per memory cell.

Referring to FIG. 19, a page buffer unit may generate first through third interleaved page data 1270, 1280 and 1290 by performing masking operations on first through third page data 1210, 1220 and 1230 using first through third pattern data 1240, 1250 and 1260.

For example, the page buffer unit may generate first masked page data (not shown) by performing a bitwise AND operation on the first page data 1210 and the first pattern data 1240, may generate second masked page data (not shown) by performing a bitwise AND operation on the second page data 1220 and the second pattern data 1250, and may generate third masked page data (not shown) by performing a bitwise AND operation on the third page data 1230 and the third pattern data 1260. The page buffer unit may generate the first interleaved page data 1270 by performing a bitwise OR operation on the first masked page data, the second masked page data and the third masked page data. Accordingly, the first interleaved page data 1270 where the first through third page data 1210, 1220 and 1230 are interleaved may be generated.

The page buffer unit may generate fourth masked page data (not shown) by performing a bitwise AND operation on the first page data 1210 and the second pattern data 1250, may generate fifth masked page data (not shown) by performing a bitwise AND operation on the second page data 1220 and the third pattern data 1260, and may generate sixth masked page data (not shown) by performing a bitwise AND operation on the third page data 1230 and the first pattern data 1240. The page buffer unit may generate the second interleaved page data 1280 by performing a bitwise OR operation on the fourth masked page data, the fifth masked page data and the sixth masked page data. Accordingly, the second interleaved page data 1280 where the first through third page data 1210, 1220 and 1230 are interleaved may be generated.

The page buffer unit may generate seventh masked page data (not shown) by performing a bitwise AND operation on the first page data 1210 and the third pattern data 1260, may generate eighth masked page data (not shown) by performing a bitwise AND operation on the second page data 1220 and the first pattern data 1240, and may generate ninth masked page data (not shown) by performing a bitwise AND operation on the third page data 1230 and the second pattern data 1250. The page buffer unit may generate the third interleaved page data 1290 by performing a bitwise OR operation on the seventh masked page data, the eighth masked page data and the ninth masked page data. Accordingly, the third interleaved page data 1290 where the first through third page data 1210, 1220 and 1230 are interleaved may be generated.

The first pattern data 1240, the second pattern data 1250 and the third pattern data 1260 may include bits of 1 at different bit positions from one another. For example, as illustrated in FIG. 19, 3M+1-th bits of the first pattern data 1240 may have values of 1, 3M+2-th bits of the second pattern data 1250 may have values of 1, and 3M+3-th bits of the third pattern data 1260 may have values of 1, where M is an integer greater than or equal to 0. However, the first pattern data 1240, the second pattern data 1250 and the third pattern data 1260 are not limited to the example illustrated in FIG. 19. Rather, the first pattern data 1240, the second pattern data 1250 and the third pattern data 1260 may be any data including bits of 1 at different bit positions from one another. The number of the bits having values of 1 included in the first through third pattern data 1240, 1250 and 1260 may be the same as the number of bits included in one pattern data or one page data.

Although FIG. 19 illustrates an example where all of the first through third page data 1210, 1220 and 1230 are interleaved, in some exemplary embodiments, the first page data 1210 and the third page data 1230 may be interleaved and programmed, and the second page data 1220 may be programmed without being interleaved. Alternatively, in other exemplary embodiments, the second page data 1220 and the third page data 1230 may be interleaved and programmed, and the first page data 1210 may be programmed without being interleaved. Additional such variations are contemplated.

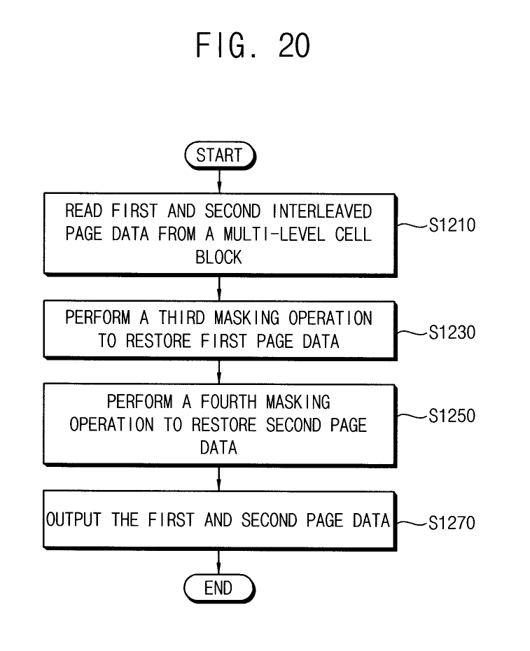

FIG. 20 is a flow chart illustrating a method of reading data in a nonvolatile memory device according to an exemplary embodiment.

Referring to FIG. 20, a nonvolatile memory device may read first interleaved page data and second interleaved page data from a multi-level cell block to a page buffer unit (S1210).

The page buffer unit may restore first page data by performing third masking operation on the first interleaved page data and the second interleaved page data (S1230). For example, the page buffer unit may generate or restore the first page data by performing a bitwise AND operation on the first interleaved page data and first pattern data, a bitwise AND operation on the second interleaved page data and second pattern data, and a bitwise OR operation on the results of the bitwise AND operations. The page buffer unit may store the first page data in first data latches (e.g., LSB data latches) included in the page buffer unit.

The page buffer unit may restore second page data by performing fourth masking operation on the first interleaved page data and the second interleaved page data (S1250). For example, the page buffer unit may generate or restore the second page data by performing a bitwise AND operation on the second interleaved page data and the first pattern data, a bitwise AND operation on the first interleaved page data and the second pattern data, and a bitwise OR operation on the results of the bitwise AND operations. The page buffer unit may store the second page data in second data latches (e.g., MSB data latches) included in the page buffer unit.

The nonvolatile memory device may output the first page data and the second page data to a memory controller (S1270). That is, the nonvolatile memory device may output the first page data stored in the first data latches and the second page data stored in the second data latches to the memory controller.

As described above, in a method of reading data in a nonvolatile memory device according to exemplary embodiments, the page buffer unit may perform the masking operations that de-interleave the first and second interleaved page data to generate or restore the first and second page data.

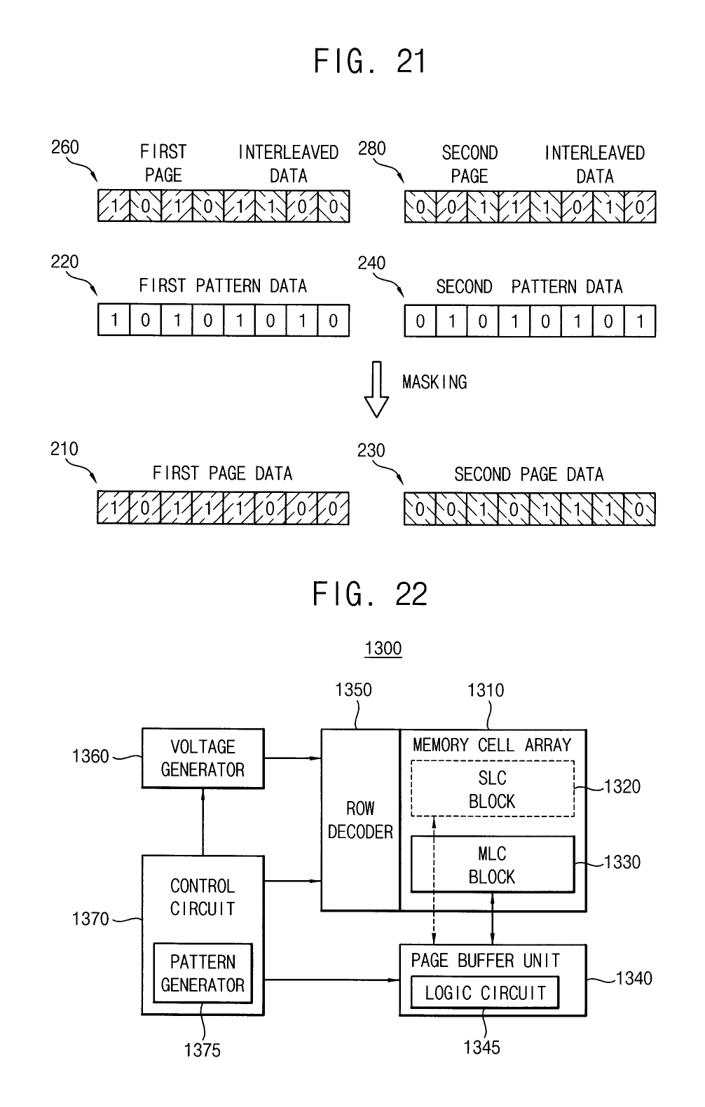

FIG. 21 is a diagram for describing an example of third and fourth masking operations in a read method of FIG. 20.

Referring to FIG. 21, first interleaved page data 260 and second interleaved page data 280 may be read from a multi-level cell block to a page buffer unit. The page buffer unit may generate or restore first page data 210 by performing a third masking operation on first interleaved page data 260 and second interleaved page data 280, and generate or restore second page data 230 by performing a fourth masking operation on the first interleaved page data 260 and the second interleaved page data 280.

For example, to generate or restore the first page data 210, the page buffer unit may perform a bitwise AND operation on the first interleaved page data 260 and first pattern data 220, may perform a bitwise AND operation on the second interleaved page data 280 and second pattern data 240, and may perform a bitwise OR operation on the results of the bitwise AND operations. Further, to generate or restore the second page data 230, the page buffer unit may perform a bitwise AND operation on the first interleaved page data 260 and the second pattern data 240, may perform a bitwise AND operation on the second interleaved page data 280 and the first pattern data 220, and may perform a bitwise OR operation on the results of the bitwise AND operations.

FIG. 22 is a block diagram illustrating an example of a nonvolatile memory device according to an exemplary embodiment.

Referring to FIG. 22, a nonvolatile memory device 1300 includes a memory cell array 1310, a page buffer unit 1340, a row decoder 1350, a voltage generator 1360 and a control circuit 1370.

The memory cell array 1310 may include at least one multi-level cell (MLC) block 1330. The multi-level cell block 1330 may include multi-level cells coupled to a plurality of wordlines and a plurality of bitlines. Each multi-level cell (MLC) may store two or more bits of data. In the multi-level cell block 1330, data interleaved by a masking operation of the page buffer unit 1340.

In some exemplary embodiments, page data provided from a memory controller may be interleaved by the masking operation of the page buffer unit 1340, and the interleaved page data may be programmed to the multi-level cell block 1330. In other exemplary embodiments, the memory cell array 1310 may further include at least one single level cell (SLC) block 1320, and the page data provided from the memory controller may be first programmed to the single level cell block 1320. Thereafter, the page data may be read from the single level cell block 1320 to the page buffer unit 1340, the read page data may be interleaved by the masking operation of the page buffer unit 1340, and the interleaved page data may be programmed to the multi-level cell block 1330. That is, the nonvolatile memory device 1300 may perform an on-chip buffer program (OBP) that uses the signal level cell block 1320 as a buffer.

The page buffer unit 1340 may operate as write drivers or sense amplifiers according to operation modes. For example, the page buffer unit 1340 may operate as the sense amplifiers in a read mode, and may operate as the write drivers in a write mode. The page buffer unit 1340 may load the page data from the memory controller or from the single level cell block 1320, and may load pattern data from a pattern generator 1375 included in the control circuit 1370. The page buffer unit 1340 may include a logic circuit 1345 that performs the masking operation to generate the interleaved page data. For example, the logic circuit 1345 may generate the interleaved page data by performing bitwise AND operations on the page data and the pattern data and a bitwise OR operation on the results of the bitwise AND operations.

The row decoder 1350 may select a wordline in response to a row address. The row decoder 1350 may apply wordline voltages from the voltage generator 1360 to selected and non-selected wordlines. During a program operation, the row decoder 1350 may apply a program voltage to the selected wordline, and may apply a pass voltage to the non-selected wordlines.

The voltage generator 1360 may be controlled by the control circuit 1370 to generate the wordline voltages, such as the program voltage, the pass voltage, a verify voltage, a read voltage, etc.

The control circuit 1370 may control the page buffer unit 1340, the row decoder 1350 and the voltage generator 1360 to program the interleaved page data to the memory cell array 1310. The control circuit 1370 may include the pattern generator 1375 that generates the pattern data. For example, the pattern generator 1375 may generate first pattern data and second patter data that are inverted from each other. According to exemplary embodiments, the pattern generator 1375 may be located inside or outside the control circuit 1370.

As described above, the pattern generator 1375 may generate the pattern data, the logic circuit 1345 included in the page buffer unit 1340 may perform the masking operation on the page data using the pattern data, and thus the interleaved page data may be generated. Accordingly, the nonvolatile memory device 1300 according to exemplary embodiments may perform interleaving and/or de-interleaving without an additional dedicated interleaving module by using the page buffer unit 1340 having a masking function, the nonvolatile memory device 1340 may efficiently equalize bit error rates (BERs) of the page data with a small size.

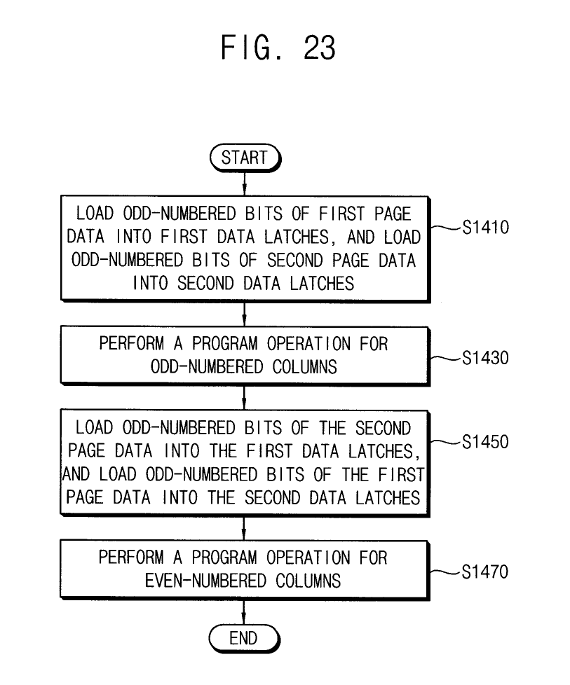

FIG. 23 is a flow chart illustrating a method of programming a nonvolatile memory device according to an exemplary embodiment.

Referring to FIG. 23, a shared bitline nonvolatile memory device may load odd numbered bits of first page data (e.g., LSB page odd column data) into first data latches (e.g., LSB data latches) included in a page buffer unit, and may load odd numbered bits of second page data (e.g., MSB page odd column data) into second data latches (e.g., MSB data latches) included in the page buffer unit (S1410). According to exemplary embodiments, the odd numbered bits of the first page data and the odd numbered bits of the second page data may be loaded from a memory controller or from a single level cell block.

The nonvolatile memory device may perform a program operation for odd-numbered columns of a multi-level cell page included in a multi-level cell block (S1430). According to exemplary embodiments, the nonvolatile memory device may perform the program operation using a shadow program method or a reprogram method. For example, the LSB page odd column data may be loaded into the LSB data latches, and may be programmed to an LSB page of the multi-level cell page. Further, the MSB page odd column data may be loaded into the MSB data latches, and may be programmed to an MSB page of the multi-level cell page.

The nonvolatile memory device may load even numbered bits of the second page data (e.g., MSB page even column data) into the first data latches (e.g., LSB data latches), and may load even numbered bits of the first page data (e.g., LSB page even column data) into the second data latches (e.g., MSB data latches) (S1450). According to exemplary embodiments, the even numbered bits of the second page data and the even numbered bits of the second page data may be loaded from a memory controller or from a single level cell block.

The nonvolatile memory device may perform a program operation for even-numbered columns of the multi-level cell page (S1470). According to exemplary embodiments, the nonvolatile memory device may perform the program operation using the shadow program method or the reprogram method. For example, the MSB page even column data may be loaded into the LSB data latches, and may be programmed to the LSB page of the multi-level cell page. Further, the LSB page even column data may be loaded into the MSB data latches, and may be programmed to the MSB page of the multi-level cell page.

Since the odd-numbered bits of the first page data (e.g., the LSB page odd column data) and the even-numbered bits of the second page data (e.g., the MSB page even column data) are programmed to the LSB page of the multi-level cell page, the LSB page may store first interleaved page data where the first page data and the second page data are interleaved. Further, since the odd-numbered bits of the second page data (e.g., the MSB page odd column data) and the even-numbered bits of the first page data (e.g., the LSB page even column data) are programmed to the MSB page of the multi-level cell page, the MSB page may store second interleaved page data where the first page data and the second page data are interleaved.

As described above, in the method of programming the nonvolatile memory device according to exemplary embodiments, either when the program operation for odd-numbered columns is performed or when the program operation for even-numbered columns is performed, page data may be programmed to a different page of a multi-level cell page from an originally intended page of the multi-level cell page. For example, when the program operation for even-numbered columns is performed, the MSB page even column data, which are originally intended to be programmed to the MSB page of the multi-level cell page, may be programmed to the LSB page of the multi-level cell page, and the LSB page even column data, which are originally intended to be programmed to the LSB page of the multi-level cell page, may be programmed to the MSB page. Accordingly, the nonvolatile memory device may perform interleaving without an additional dedicated interleaving module. The method of programming the nonvolatile memory device according to the exemplary embodiment illustrated in FIG. 23 may be applied to a shared bitline nonvolatile memory device where two columns (or two cell strings) share one bitline.

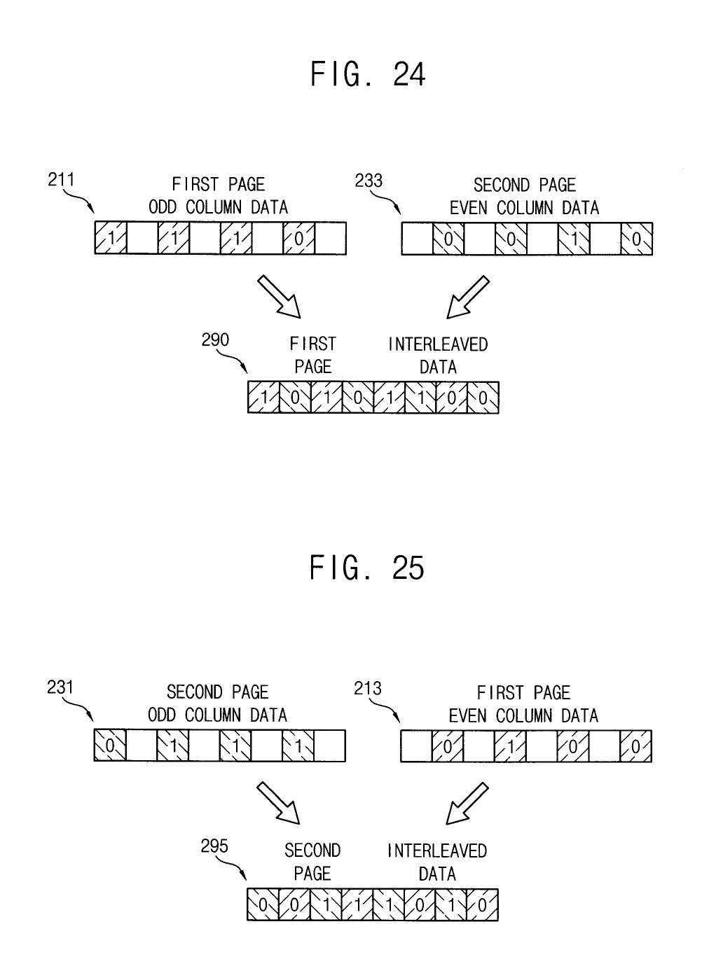

FIG. 24 is a diagram illustrating an example of first interleaved page data to be programmed by a program method of FIG. 23.

Referring to FIG. 24, a nonvolatile memory device may program odd-numbered bits 211 of first page data to a first page (e.g., an LSB page) of a multi-level cell page, and even-numbered bits 233 of second page data to the first page. Accordingly, the first page of the multi-level cell page may store first interleaved page data 290 including the odd-numbered bits 211 of the first page data and the even-numbered bits 233 of the second page data.

FIG. 25 is a diagram illustrating an example of second interleaved page data to be programmed by a program method of FIG. 23.

Referring to FIG. 25, a nonvolatile memory device may program odd-numbered bits 231 of second page data to a second page (e.g., an MSB page) of a multi-level cell page, and even-numbered bits 213 of first page data to the second page. Accordingly, the second page of the multi-level cell page may store second interleaved page data 295 including the odd-numbered bits 231 of the second page data and the even-numbered bits 213 of the first page data.

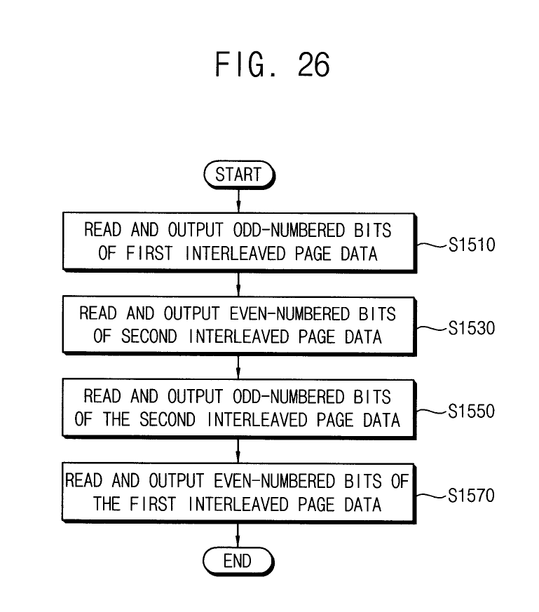

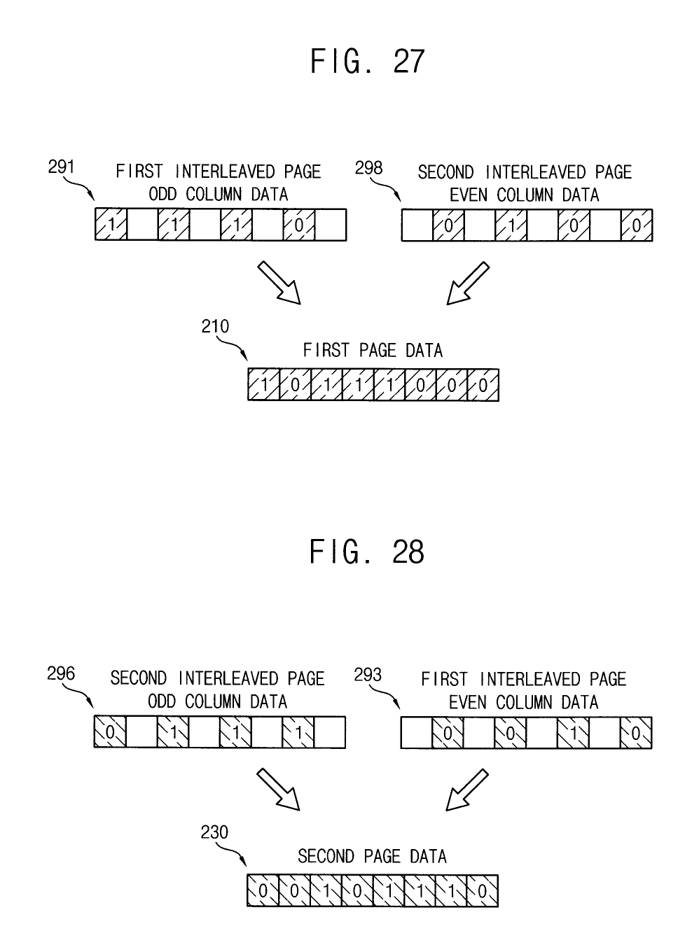

FIG. 26 is a flow chart illustrating a method of reading data in a nonvolatile memory device according to an exemplary embodiment, FIG. 27 is a diagram illustrating an example of first page data to be output by a read method of FIG. 26, and FIG. 28 is a diagram illustrating an example of second page data to be output by a read method of FIG. 26.

Referring to FIGS. 26 and 27, a shared bitline nonvolatile memory device may read odd-numbered bits 291 of first interleaved page data from a multi-level cell page of a multi-level cell block, and may output the odd-numbered bits 291 of the first interleaved page data to a memory controller (S1510). Further, the nonvolatile memory device may read even-numbered bits 298 of second interleaved page data from the multi-level cell page, and may output the even-numbered bits 298 of the second interleaved page data to the memory controller (S1530). Since the odd-numbered bits 291 of the first interleaved page data correspond to odd-numbered bits of first page data 210, and the even-numbered bits 298 of the second interleaved page data correspond to even-numbered bits of the first page data 210, the memory controller may restore the first page data 210 by receiving the odd-numbered bits 291 of the first interleaved page data and the even-numbered bits 298 of the second interleaved page data from the nonvolatile memory device.

Referring to FIGS. 26 and 28, the nonvolatile memory device may read odd-numbered bits 296 of the second interleaved page data from the multi-level cell page, and may output the odd-numbered bits 296 of the second interleaved page data to the memory controller (S1550). Further, the nonvolatile memory device may read even-numbered bits 293 of the first interleaved page data from the multi-level cell page, and may output the even-numbered bits 293 of the first interleaved page data to the memory controller (S1570). Since the odd-numbered bits 296 of the second interleaved page data correspond to odd-numbered bits of second page data 230, and the even-numbered bits 293 of the first interleaved page data correspond to even-numbered bits of the second page data 230, the memory controller may restore the second page data 230 by receiving the odd-numbered bits 296 of the second interleaved page data and the even-numbered bits 293 of the first interleaved page data from the nonvolatile memory device.

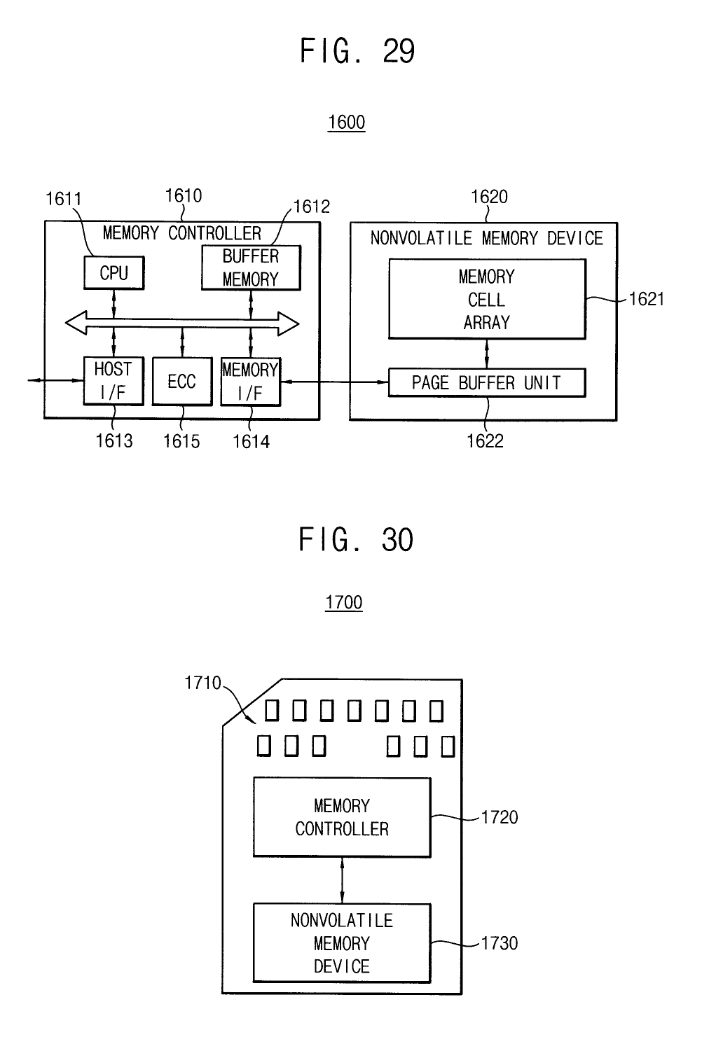

FIG. 29 is a block diagram illustrating a memory system according to an exemplary embodiment.

Referring to FIG. 29, a memory system 1600 includes a memory controller 1610 and a nonvolatile memory device 1620.

The nonvolatile memory device 1620 includes a memory cell array 1621 and a page buffer unit 1622. The page buffer unit 1622 may load page data from the memory controller 1610 or from a single level cell block included in the memory cell array 1621. In some exemplary embodiments, the page buffer unit 1622 may generate interleaved page data by performing selective dump operations on the loaded page data. In other exemplary embodiments, the page buffer unit 1622 may generate the interleaved page data by performing masking operations on the loaded page data. In still other exemplary embodiments, the nonvolatile memory device 1620 may be a shared bitline nonvolatile memory device, and may program the interleaved page data to a multi-level cell page such that the loaded page data are programmed to a different page of the multi-level cell page from an originally intended page of the multi-level cell page either when an odd column program operation is performed or when an even column program operation is performed.

The memory controller 1610 may control the nonvolatile memory device 1620. The memory controller 1610 may control data transfer between an external host (not shown) and the nonvolatile memory device 1620. The memory controller 1610 may include a central processing unit (CPU) 1611, a buffer memory 1612, a host interface (I/F) 1613 and a memory interface 1614. The central processing unit 1611 may perform operations for the data transfer. The buffer memory 1612 may be implemented by a dynamic random access memory (DRAM), a static random access memory (SRAM), a phase random access memory (PRAM), a ferroelectric random access memory (FRAM), a resistive random access memory (RRAM), a magnetic random access memory (MRAM), etc. According to exemplary embodiments, the buffer memory 1612 may be located inside or outside the memory controller 1610.

The host interface 1613 may be coupled to the host, and the memory interface 1614 may be coupled to the nonvolatile memory device 1620. The central processing unit 1611 may communicate with the host via the host interface 1613. For example, the host interface 1613 may be configured to communicate with the host using at least one of various interface protocols, such as a universal serial bus (USB), a multi-media card (MMC), a peripheral component interconnect-express (PCI-E), a small computer system interface (SCSI), a serial-attached SCSI (SAS), a serial advanced technology attachment (SATA), a parallel advanced technology attachment (PATA), an enhanced small disk interface (ESDI), integrated drive electronics (IDE), etc. Further, the central processing unit 1611 may communicate with the nonvolatile memory device 1620 via the memory interface 1614. In some exemplary embodiments, the memory controller 1610 may further include an error correction code (ECC) block 1615 for error correction. According to exemplary embodiments, the memory controller 1610 may be built in the nonvolatile memory device 1620, or the memory controller 1610 and the nonvolatile memory device 1620 may be implemented as separate chips.

The memory system 1600 may be implemented as a memory card, a solid state drive, etc. In some exemplary embodiments, the nonvolatile memory device 1620, the memory controller 1610 and/or the memory system 1600 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

FIG. 30 is a diagram illustrating a memory card including a memory system according to an exemplary embodiment.

Referring to FIG. 30, a memory card 1700 may include a plurality of connecting pins 1710, a memory controller 1720 and a nonvolatile memory device 1730.

The connecting pins 1710 may be coupled to a host (not shown) to transfer signals between the host and the memory card 1700. The connecting pins 1710 may include a clock pin, a command pin, a data pin and/or a reset pin, etc.

The memory controller 1720 may receive data from the host, and may store the received data in the nonvolatile memory device 1730.

The nonvolatile memory device 1730 may include a page buffer unit. The page buffer unit may interleave page data by performing a selective dump operation or a masking operation. Alternatively, in a case where the nonvolatile memory device 1730 is a shared bitline nonvolatile memory device, the nonvolatile memory device 1730 may interleave the page data such that the page data are programmed to a different page of a multi-level cell page from an originally intended page of the multi-level cell page either when an odd column program operation is performed or when an even column program operation is performed.

For example, the memory card 1700 may include a multimedia card (MMC), an embedded multimedia card (eMMC), a hybrid embedded multimedia card (hybrid eMMC), a secure digital (SD) card, a micro-SD card, a memory stick, an identity (ID) card, a personal computer memory card international association (PCMCIA) card, a chip card, a USB card, a smart card, a compact flash (CF) card, etc.

In some exemplary embodiments, the memory card 1700 may be coupled to the host, such as a desktop computer, a laptop computer, a tablet computer, a mobile phone, a smart phone, a music player, a personal digital assistants (PDA), a portable multimedia player (PMP), a digital television, a digital camera, a portable game console, etc.

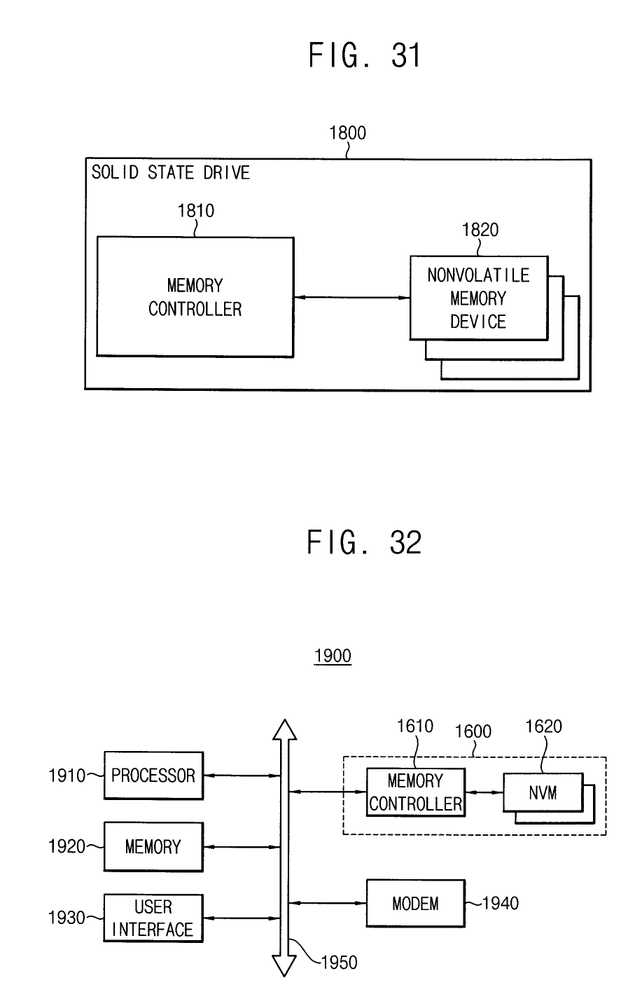

FIG. 31 is a diagram illustrating a solid state drive including a memory system according to an exemplary embodiment.

Referring to FIG. 31, a solid state drive (SSD) 1800 includes a memory controller 1810 and a plurality of nonvolatile memory devices 1820.

The memory controller 1810 may receive data from a host (not shown). The memory controller 1810 may store the received data in the plurality of nonvolatile memory devices 1820.

Each nonvolatile memory device 1820 may include a page buffer unit. The page buffer unit may interleave page data by performing a selective dump operation or a masking operation. Alternatively, in a case where the nonvolatile memory device 1820 is a shared bitline nonvolatile memory device, the nonvolatile memory device 1820 may interleave the page data such that the page data are programmed to a different page of a multi-level cell page from an originally intended page of the multi-level cell page either when an odd column program operation is performed or when an even column program operation is performed.

In some exemplary embodiments, the solid state drive 1800 may be coupled to the host, such as a mobile device, a mobile phone, a smart phone, a PDA, a PMP, a digital camera, a portable game console, a music player, a desktop computer, a notebook computer, a tablet computer, a speaker, a video, a digital television, etc.

FIG. 32 is a diagram illustrating a computing system according to an exemplary embodiment.

Referring to FIG. 32, a computing system 1900 includes a processor 1910, a memory 1920, a user interface 1930 and a memory system 1600. In some exemplary embodiments, the computing system 1900 may further include a modem 1940, such as a baseband chipset.

The processor 1910 may perform specific calculations or tasks. For example, the processor 1910 may be a microprocessor, a central processing unit (CPU), a digital signal processor, or the like. The processor 1910 may be coupled to the memory 1920 via a bus 1950, such as an address bus, a control bus and/or a data bus. For example, the memory 1920 may be implemented by a DRAM, a mobile DRAM, a SRAM, a PRAM, a FRAM, a RRAM, a MRAM and/or a flash memory. Further, the processor 1910 may be coupled to an extension bus, such as a peripheral component interconnect (PCI) bus, and may control the user interface 1930 including at least one input device, such as a keyboard, a mouse, a touch screen, etc., and at least one output device, a printer, a display device, etc. The modem 1940 may perform wired or wireless communication with an external device. The nonvolatile memory device 1620 may be controlled by a memory controller 1610 to store data processed by the processor 1910 or data received via the modem 1940. In some exemplary embodiments, the computing system 1900 may further include a power supply, an application chipset, a camera image processor (CIS), etc.

The inventive concept may be applied to any nonvolatile memory device, and devices and systems including the nonvolatile memory device. For example, the inventive concept may be applied to various electronic devices, such as a memory card, a solid state drive, a desktop computer, a laptop computer, a tablet computer, a mobile phone, a smart phone, a music player, a PDA, a PMP, a digital television, a digital camera, a portable game console, etc.

As described above, the method of programming the nonvolatile memory device according to exemplary embodiments may perform a selective dump operation or a masking operation using a page buffer unit, and thus may efficiently interleave page data without an additional dedicated interleaving module. Further, the method of programming the nonvolatile memory device according to exemplary embodiments may reduce a difference between bit error rates for respective page data by interleaving page data using the page buffer unit.

The foregoing is illustrative of exemplary embodiments and is not to be construed as limiting thereof. Although a few exemplary embodiments have been described, those skilled in the art will readily appreciate that many modifications are possible in the exemplary embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various exemplary embodiments and is not to be construed as limited to the specific exemplary embodiments disclosed, and that modifications to the disclosed exemplary embodiments, as well as other exemplary embodiments, are intended to be included within the scope of the appended claims.

What is claimed is:

1. A method of programming a nonvolatile memory device that includes a page buffer unit, the method comprising:
loading first page data and second page data into the page buffer unit;
performing, by the page buffer unit, a first selective dump operation on the first page data and the second page data to generate first interleaved page data;
performing, by the page buffer unit, a second selective dump operation on the first page data and the second page data to generate second interleaved page data; and
programming the first interleaved page data and the second interleaved page data into a multi-level cell block.

2. The method of claim 1, wherein the page buffer unit includes first data latches, second data latches, and sensing latches, and wherein performing the first selective dump operation comprises:
writing the first page data to the sensing latches;
dumping, by the sensing latches, odd-numbered bits of the first page data from the sensing latches to odd-numbered latches of the first data latches;
writing the second page data to the sensing latches; and
dumping, by the sensing latches, even-numbered bits of the second page data from the sensing latches to even-numbered latches of the first data latches.

3. The method of claim 2, wherein performing the second selective dump operation comprises:
writing the second page data to the sensing latches;
dumping, by the sensing latches, odd-numbered bits of the second page data from the sensing latches to odd-numbered latches of the second data latches;
writing the first page data to the sensing latches; and
dumping, by the sensing latches, even-numbered bits of the first page data from the sensing latches to even-numbered latches of the second data latches.

4. The method of claim 1, wherein loading the first page data and the second page data into the page buffer unit comprises:
loading the first page data from a memory controller to first data latches included in the page buffer unit; and
loading the second page data from the memory controller to second data latches included in the page buffer unit.

5. The method of claim 1, further comprising:
programming the first page data and the second page data provided from a memory controller into a first page and a second page, respectively, of a single level cell block, and
wherein loading the first page data and the second page data into the page buffer unit comprises:
loading the first page data from the first page of the single level cell block to first data latches included in the page buffer unit; and
loading the second page data from the second page of the single level cell block to second data latches included in the page buffer unit.

6. The method of claim 1, wherein programming the first interleaved page data and the second interleaved page data into the multi-level cell block comprises:
performing a least significant bit (LSB) program operation that programs multi-level cells included in the multi-level cell block to threshold voltage states corresponding to LSBs based on the first interleaved page data; and
performing a most significant bit (MSB) program operation that programs the multi-level cells to threshold voltage states corresponding to MSBs based on the second interleaved page data.

7. The method of claim 1, wherein programming the first interleaved page data and the second interleaved page data into the multi-level cell block comprises:
performing a pre-program operation that programs multi-level cells included in the multi-level cell block to first threshold voltage states based on the first interleaved page data and the second interleaved page data; and
performing a reprogram operation that programs the multi-level cells to second threshold voltage states narrower than the first threshold voltage states based on the first interleaved page data and the second interleaved page data.

8. The method of claim 1, wherein the first page data are least significant bit (LSB) page data, and the second page data are most significant bit (MSB) page data.

9. A method of programming a nonvolatile memory device including a page buffer unit, the method comprising:
loading first page data and second page data into the page buffer unit;
performing, by the page buffer unit, a first masking operation on the first page data and the second page data using first pattern data and second pattern data, respectively, to generate first interleaved page data;
performing, by the page buffer unit, a second masking operation on the first page data and the second page data using the second pattern data and the first pattern data, respectively, to generate second interleaved page data; and
programming the first interleaved page data and the second interleaved page data into a multi-level cell block.

10. The method of claim 9, wherein performing the first masking operation comprises:
generating first masked page data by performing a bitwise AND operation on the first page data and the first pattern data;
generating second masked page data by performing a bitwise AND operation on the second page data and the second pattern data; and
generating the first interleaved page data by performing a bitwise OR operation on the first masked page data and the second masked page data.

11. The method of claim 10, wherein performing the second masking operation comprises:
generating third masked page data by performing a bitwise AND operation on the first page data and the second pattern data;
generating fourth masked page data by performing a bitwise AND operation on the second page data and the first pattern data; and
generating the second interleaved page data by performing a bitwise OR operation on the third masked page data and the fourth masked page data.

12. The method of claim 9, wherein each bit of the second pattern data has an opposite value to a corresponding bit of the first pattern data.

13. The method of claim 12, wherein odd-numbered bits of the first pattern data have values of 1, and even-numbered bits of the first pattern data have values of 0, and wherein odd-numbered bits of the second pattern data have values of 0, and even-numbered bits of the first pattern data have values of 1.

14. The method of claim 9, further comprising:
loading third page data into the page buffer unit; and
performing a third masking operation to generate third interleaved page data,
wherein the first masking operation, the second masking operation, and the third masking operation are performed using the first pattern data, the second pattern data, and third pattern data, and
wherein the first pattern data, the second pattern data, and the third pattern data include bits of 1 at different bit positions from one another.

15. The method of claim 14, wherein 3M+1-th bits of the first pattern data have values of 1,
3M+2-th bits of the second pattern data have values of 1, and
3M+3-th bits of the third pattern data have values of 1, where M is an integer greater than or equal to 0.

16. The method of claim 1, wherein the first interleaved page data and the second interleaved page data are generated without the nonvolatile memory device using a dedicated interleaving module.

17. A method of programming a nonvolatile memory device that includes a multi-level cell block, and a page buffer including data latches and sensing latches, the method comprising:
loading first page data and second page data into the data latches of the page buffer; and
performing interleaving of the first page data and the second page data using the sensing latches of the page buffer to produce interleaved page data;
programming the interleaved page data into the multi-level cell block of the nonvolatile memory device.

18. The method of claim 17, wherein the interleaving is performed to produce the interleaved page data in the data latches of the page buffer.

19. The method of claim 17, wherein the interleaving interleaves most significant bits (MSBs) and least significant bits (LSBs) of the first page data and the second page data in order to reduce an error correction code (ECC) overhead of the nonvolatile memory device.

20. The method of claim 17, wherein the nonvolatile memory device further comprises a single-level cell block,
wherein the first page data and the second page data are loaded into the data latches of the page buffer from the single-level cell block.
